(19) United States
(12) Patent Application Publication
(10) Pub. No.: US 2003/0146551 A1
(43) Pub. Date: Aug. 7, 2003

(54) Blow-molding large, relatively thick-walled, thermoplastic resin products

(76) Inventor: Bruce V. Weeks, Pataskala, OH (US)

Correspondence Address: Weeks, Bruce V., 5874 Blendon Place Drive, Columbus, OH, 43230, US

(21) Appl. No.: 10/061,818

(22) Filed: Feb. 1, 2002

(51) Int. Cl. B29C 49/50

(52) U.S. Cl. 264/536; 425/527

(57) ABSTRACT

A blow-mold assembly for use with a conventional production blow-molding machine is provided with co-operating and separable cap and base blow-mold sub-assemblies, the base blow-mold sub-assembly having elongate and pivoted gutter plate segments that together surround the product mold cavity of the assembly, that each may each be moved in directions toward and away from the cap blow-mold sub-assembly to control certain wall thickness and configuration characteristics of the blow-molded product formed in the product mold cavity, and that may each be pivoted in a plane at right angles relative to the direction of gutter plate segment movement for wall thickness characteristic control to thereby progressively separate gutter flash from around the blow-molded product while the product is retained in the apparatus product mold cavity.

### CROSS-REFERENCES

None.

### FIELD OF THE INVENTION

The present invention relates generally to the manufacture of large, relatively thick-walled, blow-molded, thermoplastic-resin products, and particularly concerns both methods and apparatus for accomplishing the separation of gutter flash that is first integrally attached to a large, relatively thick-walled, blow-molded product from the product entirely around the product mold-line perimeter while the product is fully restrained in the product-forming mold cavity of the invention apparatus.

### BACKGROUND OF THE INVENTION

It is common practice in the United States in connection with the manufacture of large, relatively thick-walled blow-molded thermoplastic resin products using conventional production blow-molding machines and known blow-mold assemblies to eject the molded product with simultaneously formed and completely surrounding gutter flash from the mold assembly, and to afterwards completely separate the integrally attached flash from the ejected blow-molded product by subsequent combined operations such as sequential cutting and grinding or sequential shearing and grinding. The operating forces and processing time required to so-separate and remove such flash, either manually or by machine, are, in the case of many blow-molded products, extremely large. The required flash separation forces and flash removal process times are especially substantial in cases where the blow-molding machine production cycle unit output is comprised of either a single blow-molded product or multiple blow-molded products with integrally attached gutter flash having a substantial total length of gutter flash trim edge.

In the teachings of U.S. Pat. No. 5,480,607 granted to Hobson a method of separating integrally attached flash from a product during the molding process is disclosed, but such method utilizes a step wherein the flash is temporarily secured to the apparatus blow-mold and the formed product is separated from the restrained integral flash by applying product mold ejector pin forces to the blow-molded product with the mold assembly in a partially open condition. The ejection forces required may be undesirably large and also generally cause ejector pin damage to the formed product in high-rate production cycles wherein the blow-molded product has an elevated temperature and a substantial degree of residual parison plasticity at time of flash separation and product ejection from its mold.

I have discovered a novel method of progressively separating integrally-attached gutter flash from a blow-molded product, and also novel mold assembly constructions and methods of assembly operation, that may be used in conjunction with a conventional production blow-molding machine to achieve complete, or very nearly complete, separation of otherwise integrally attached surrounding gutter flash from blow-molded products while the products are fully restrained by the mold apparatus and prior to product ejection from within the mold apparatus. Subsequently the individual blow-molded thermoplastic resin products and separated gutter flash are ejected from the mold assemblies in which they were formed and removed from the co-operating conventional production blow-molding machine. Because very short blow-molding machine operating cycle unit times may be achieved with the novel in-mold product de-flashing, and because the apparatus takes advantage of separate product and gutter flash removal procedures, the blow-molded thermoplastic resin products and separate gutter flash have no possibility of being inadvertently fused together.

In addition, when it has been discovered that the wall thickness configuration characteristic of the produced blow-molded product in the region of the product mold parting-line perimeter is not that which is desired, e.g. is convex or of uniform wall thickness rather than concave, is concave or of uniform wall thickness rather than convex, etc., it has been necessary and costly to rather extensively re-work the blow-mold assembly to obtain correction to the desired product wall thickness configuration at the product mold parting line perimeter. I have found that the required rather extensive blow-mold assembly re-working is not necessary if using the improved blow-mold apparatus of the present invention.

Other objects and advantages of the present invention will become apparent during consideration of the detailed descriptions, drawings, and claims which follow.

### SUMMARY OF THE INVENTION

I have invented a blow-mold assembly that is intended for use with a conventional production blow-molding machine and that is comprised of co-operating and separable cap and base blow-mold sub-assemblies, the base blow-mold sub-assembly having multiple elongated gutter plate segments which together surround the blow-mold assembly product mold cavity when abutted, which each may be moved linearly in directions toward or away from the cap blow-mold sub-assembly to obtain different product wall thickness and internal surface configuration characteristics at the product mold parting-line perimeter, and which also are pivoted or rotated in directions transverse to the direction of linear gutter plate segment movement to progressively separate gutter flash from around the blow-molded product while the product is retained in the apparatus product mold cavity. Further, the blow-mold assembly invention, with modification, is useful for additionally separating from the product a gutter flash core integrally attached to the product at a product interior mold parting-line perimeter also while the product is retained in the apparatus product mold cavity.

Several different blow-mold assembly embodiments and methods of blow-molding a product for implementing the invention are disclosed and described in detail.

### BRIEF DESCRIPTION OF THE DRAWINGS

FIG. 1 is a schematic perspective view of a conventional production blow-molding machine within which the methods and apparatus of the present invention may be practiced;

FIG. 2 is a schematic elevation view of the interior of the blow-molding machine of FIG. 1 illustrating a preferred embodiment the base and cap blow-mold sub-assemblies of the present invention in an operationally separated condition;

FIG. 3 is similar to FIG. 2 except that the included invention cap and base blow-mold sub-assemblies are illustrated in an operationally closed condition;

FIG. 4 is similar to FIG. 3 except that it is a plan view of a the interior of the blow-molding machine of FIG. 1 illustrating the blow-mold sub-assemblies of the present invention in a fully closed condition;

FIG. 5 is an orthogonal view of the invention base blow-mold sub-assembly shown in FIGS. 2 through 4 in an initial operating condition;

FIG. 6 is an orthogonal view of the invention base blow-mold sub-assembly similar to FIG. 3 but in a subsequent operating condition;

FIG. 7 is a section view taken at line 7-7 of FIG. 3 in an invention blow-mold assembly initial operating condition;

FIG. 8 is a view similar to FIG. 7 but in an invention blow-mold assembly subsequent operating condition;

FIG. 9 is an enlarged view of the portion of FIG. 7 circled with a dotted line;

FIG. 10 is an enlarged view of the portion of FIG. 8 circled with a dotted line;

FIG. 11 is a section view taken at line 11-11 of FIG. 13;

FIG. 12 is a schematic plan view of the product that is blow-molded in the apparatus of FIGS. 1 through 11 and its fully-separated gutter flash;

FIG. 13 is a schematic front elevation view of the invention FIG. 5 base blow-mold sub-assembly but with the gutter plate segments surrounding the mold cavity having an alternate configuration;

FIG. 14 is a schematic diagram of one form of control system that may be utilized to obtain proper sequencing of the several bi-directional actuator devices incorporated in the apparatus of FIGS. 1 through 11;

FIGS. 15 through 17 are section views similar to FIG. 9 but illustrating the different product parting line perimeter wall thickness or wall internal surface characteristics that can be obtained by practice of the present invention;

FIG. 18 is an orthogonal view of another embodiment of the invention base blow-mold sub-assembly shown in an initial operating condition;

FIG. 19 is an orthogonal view of the invention base blow-mold sub-assembly of FIG. 18 in a subsequent operating condition;

FIG. 20 is a schematic section view taken at line 20-20 of FIG. 18;

FIG. 21 is a schematic section view taken at line 21-21 of FIG. 18 to illustrate included gutter flash ejector pin elements in a retracted operating condition;

FIG. 22 is similar to FIG. 21 but illustrating the included gutter flash ejector pin elements in a subsequent extended operating condition;

FIG. 23 is an elevation view illustrating the molded part and gutter flash components that are ejected from the blow-molding machine of FIGS. 1 through 4 when utilizing the base blow-mold sub-assembly of FIGS. 18 and 19;

FIG. 24 is an schematic orthogonal view of still another embodiment of the invention base blow-mold sub-assembly in an initial operating condition;

FIG. 25 is a schematic section view taken at line 25-25 of FIG. 24 to illustrate included invention internal crash pad elements in an extended operating condition;

FIG. 26 is similar to FIG. 25 but illustrating the included crash pad elements in a retracted operating condition;

FIG. 27 is a schematic section view taken at line 27-27 of FIG. 24 to illustrate included gutter plate segment support pin elements in a first operating condition;

FIG. 28 is similar to FIG. 27 but illustrating the included gutter plate support pin elements in a different operating condition;

FIGS. 29 and 30 schematically and orthogonally respectively illustrate additional cap blow-mold sub-assembly and base blow-mold sub-assembly constructions that may be utilized in another application for the invention apparatus using the blow-molding machine of FIGS. 1 through 4;

FIG. 31 is a section view illustrating the blow-mold sub-assemblies of FIGS. 29 and 30 in an assembled and first operating condition;

FIG. 32 is a section view similar to FIG. 31 but illustrating the sub-assemblies in a second operating condition;

FIG. 33 is an enlarged view of the portion of FIG. 32 circled with a dotted line;

FIG. 34 is a schematic orthogonal view of yet another embodiment of the base blow-mold sub-assembly of the present invention;

FIG. 35 is a section view through the invention blow-mold assembly taken, with blow-molded product in place, at line 35-35 of FIG. 34;

FIG. 36 is a plan view of the product mold half included in the base blow-mold sub-assembly of FIG. 34;

FIG. 37 is a section view taken at line 37-37 of FIG. 34;

FIG. 38 is a schematic front elevation view of another embodiment of the base blow-mold sub-assembly of the present invention with the included elongate and double-pivoted gutter plate segments in an initial operating condition;

FIG. 39 is a view similar to FIG. 38 but illustrating the included elongate and double-pivoted gutter plate segments in a subsequent operating condition;

FIG. 40 is a back elevation view schematically illustrating a first embodiment of the of the FIGS. 38 and 39 base blow-mold sub-assembly gutter plate segment drive;

FIG. 41 is similar to FIG. 40 but schematically illustrating a second or different embodiment of the FIGS. 38 and 39 base blow-mold sub-assembly gutter plate segment drive;

FIG. 42 is a partial break-away orthogonal view of the base blow-mold sub-assembly corner area construction utilized in invention embodiments of FIGS. 38 through 41;

FIG. 43 is a schematic front elevation view of a base blow-mold sub-assembly construction for use in effecting progressive separation of an integrally attached gutter flash interior core from a blow-molded product, and illustrated in an initial operating condition;

FIG. 44 is similar to FIG. 43 but illustrating the blow-mold sub-assembly in a subsequent operating condition;

FIG. 45 is a back elevation view schematically illustrating a first embodiment of the of the FIGS. 43 and 44 base blow-mold sub-assembly gutter plate segment drive;

FIG. 46 is a section view taken at line 46-46 of FIG. 43; and

FIG. 47 is a section view taken at line 47-47 of FIG. 44.

### DETAILED DESCRIPTION

The method of the present invention involves a basic step sequence of blow-molding an extruded and heated thermoplastic resin parison contained within co-operating and operationally closed blow-mold sub-assemblies to form a large, relatively thick-walled, hollow product with a gutter flash integrally attached to the product entirely around the product mold parting-line perimeter, separating the integrally attached gutter flash from the blow-molded product progressively along each product mold parting-line perimeter side, and afterwards separating the closed blow-mold sub-assemblies for purposes of accomplishing removal of the product and separated gutter flash from the blow-mold apparatus. The forces applied to the gutter flash during such progressive gutter flash separation are essentially tension forces rather than conventional cutting or shear forces.

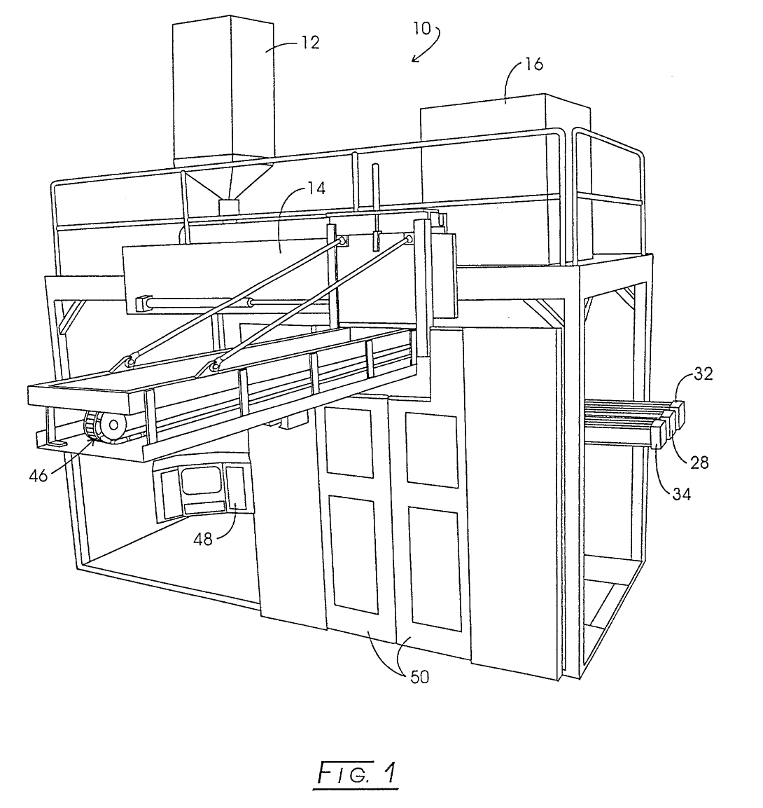

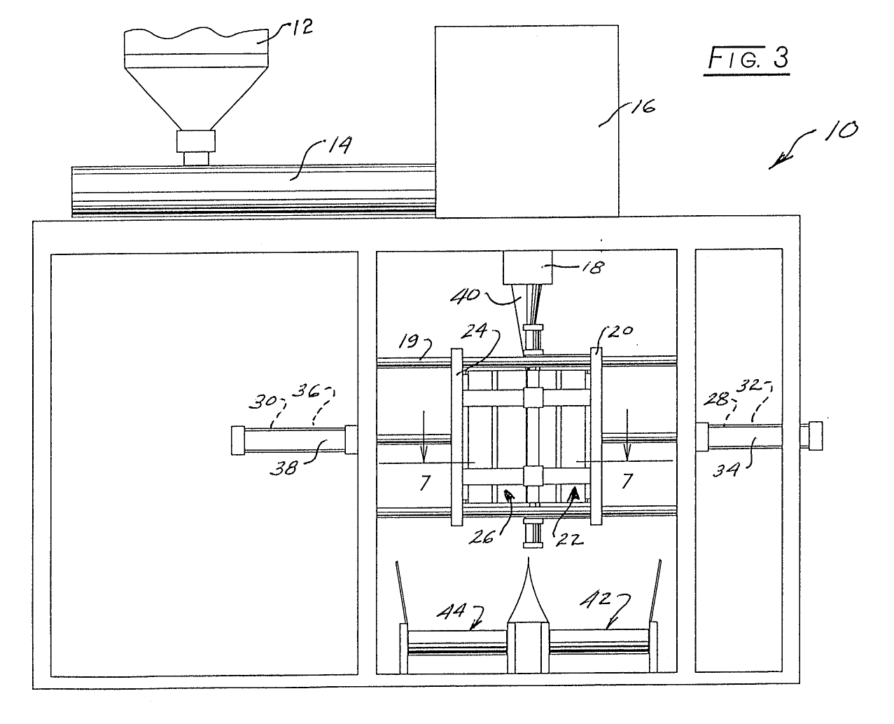

FIGS. 1 through 3 schematically illustrate a conventional industrial blow molding machine 10, such as the large-size either SE or SL Series “Sterling” blow molding system manufactured and marketed by Davis-Standard Corporation of Edison N.J., customized to include the blow-mold assemblies utilized in the practice of the present invention.. Such machine generally has a throat size that often ranges to approximately 84 inches by 60 inches, and is especially well adapted to the production in each machine cycle of a single very large blow-molded product utilizing an extremely short production cycle time generally varying from approximately 45 to 60 seconds per cycle. The production rates for machine 10 typically are in the range from 60 to 80 or more units per hour of a large, relatively thick-walled, blow-molded product. Such machine is capable of blow-molding a variety of different thermoplastic resins including polyolefin resins and other resins such as polycarbonate, polyethylene, polyvinylchloride, and like resins that are technically-formulated for use in blow-molding applications.

Machine 10 typically includes the illustrated feedstock hopper 12, a feed screw feedstock conveyor 14, and a conventional melter-accumulator-extruder sub-assembly 16 with variably-controlled parison die head 18. Machine 10 also includes guideposts 19 upon which movable platens 20 and 24 reciprocate. Movable machine platen 20 carries base blow-mold sub-assembly 22 and movable machine platen 24 carries cap blow-mold sub-assembly 26. Although such base and cap blow-mold sub-assemblies have co-operating complementary product-forming cavities and generally similar constructions, their respective total function differs.

Machine platen 20 is powered by bi-directional rapid traverse hydraulic actuator 28 and additionally by bi-directional clamping hydraulic actuators 32 and 34; machine platen 24 is powered by bi-directional rapid traverse hydraulic actuator 30 and additionally by bi-directional clamping hydraulic actuators 36 and 38. In addition, conventional blow-molding machine 10 typically includes trimmed blow-mold product discharge conveyor 42, flash discharge conveyor 44, and may optionally also include a conventional overhead discharge conveyor 46 (see FIG. 1) normally utilized for removing conventionally formed product units with integrally attached flash from within the machine. Machine 10 typically also includes a operator's control panel or control station 48 and access doors 50 which, when opened, provide access to the interiorly-located invention blow-mold sub-assemblies 22 and 26 for installation and maintenance servicing purposes and the like.

As shown in FIGS. 4 and 5, base mold sub-assembly 22 is provided with a base plate 60 to which are rigidly attached slotted platen mounting blocks 62 and 64, intermediate support block 66, and external crash pads 68 and 70 which function to maintain a proper base blow-mold sub-assembly distance of separation from cap blow-mold sub-assembly 26 when such blow-mold sub-assemblies are positioned in an operationally closed condition with respect to each other, usually a small distance generally not exceeding approximately ten thousandths (0.010) of an inch and often to as little as approximately one thousandth (0.001) of an inch, the separation in that range utilized in a particular apparatus blow-mold assembly being controlled in some instances by the selection and installation of multiple sets of different hereinafter-described shim combinations. Also, this separation distance may increase somewhat both when pressurized air is being injected into the interior of the parison segment constrained by the mold sub-assemblies during product formation, and also after the actuators forcing the mold sub-assemblies together are relieved of internal fluid pressures prior to opening the mold sub-assemblies for product and gutter flash removal purposes. Crash pads 70 each have a projecting tapered guide pin 72 that co-operates with a complementary crash pad tapered guide pin receptacle 74 provided in a crash pad element 68.

Base blow-mold sub-assembly 22 also includes product mold half 80 that is rigidly mounted on base plate 60, and that has a product cavity half 82, pneumatically-actuated conventional bi-directional product ejectors 84, and a pneumatically-actuated extendible and retractable inflation needle 86 that injects pressurized air into the interior of parison 40 to effect parison expansion. Elongate gutter plate segments 90, 92, 94, and 96, together surround cavity 82 of product mold half 80 at the cavity mold parting-line perimeter when their ends each abut the ends of an adjacent gutter plate segment . The essentially flat surface of each such gutter plate segment that opposes and is nearest cap blow-mold sub-assembly 26 is a gutter flash clamping surface designated in the drawings with the reference numeral 87, and includes an excess gutter flash receiver 98 which in FIGS. 5 through 13 takes the form of multiple, excess gutter flash, tapered blind-hole recesses. As discussed in connection with FIGS. 15 through 17, each such receiver element 98 is provided for the purpose of accommodating excess heated parison material associated with the particular distance that separates the gutter flash clamping surface 83 of cap blow-mold sub-assembly 26 from the gutter flash clamping surfaces 87 of the sub-assembly 22 pivoted gutter plate segments. Also, each such gutter plate segment included in mold sub-assembly 22 preferably includes multiple, conventional, bi-directionally and pneumatically-actuated gutter flash ejectors 100, a longitudinal coolant passageway 102, and an upstanding integral gutter flash separation blade element 97 positioned transversely at one or at each extreme end region of each elongated gutter plate segment. See FIG. 11. Blade element 97 substantially cuts through said gutter flash to enable said gutter plate segments 90, 92, 94, and 96 to pivot and progressively tear said gutter flash.

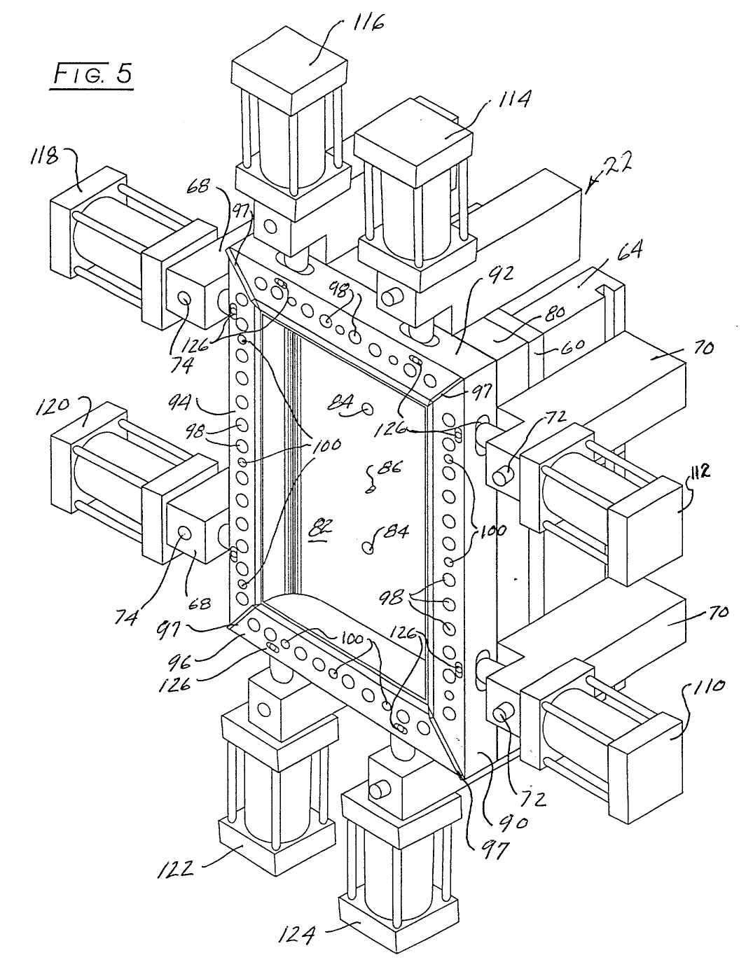

Cap blow-mold sub-assembly 26, although constructed to be generally similar to base blow-mold sub-assembly 22 with respect to its basic components, has a somewhat different total function than does its co-operating base blow-mold sub-assembly 22. The cap blow-mold sub-assembly's mold half, which is designated 81 in FIGS. 5 through 10 and which together with co-operating product mold half 80 comprises the apparatus product mold with an interior product-forming cavity 82, has an integral gutter with gutter flash clamping surface 83 which completely surrounds the product cavity periphery areas situated opposite the gutter flash clamping surfaces 87 of gutter plate segments 90 through 96. Such cap blow-mold sub-assembly flat gutter flash clamping surface 83 also preferably diverges away from the gutter flash clamping surfaces 87 of the gutter plate segments of base blow-mold sub-assembly 22 outwardly from the product cavity mold parting-line perimeter 108. The resulting “taper” is preferably at least about a 1° angular departure, sometimes is imparted to a flat continuous gutter flash clamping surface 83, but optionally and often preferably, may advantageously includes an intermediate step or offset 85 located outwardly of mold parting-line perimeter 108—usually about ¾ inch from the parting-line perimeter, and just outwardly of the position of concave excess gutter flash receiver or cleat 98 or its elements provided in the different invention gutter plate segment configurations. See FIG. 10. Also, since blow-mold sub-assembly 26 does not support any of the invention pivoted and abutting gutter plate segments it is not provided with bi-directional hydraulic actuators for effecting pivotal movement of the invention gutter plate segments. While it is important that each gutter plate segment of sub-assembly 22 is provided with a longitudinal cooling water passageway 102 that is connected to a flowing source of liquid coolant such as cooling water, it is also important that product mold halves 80 and 81 of blow-mold subassemblies 22 and 26 each be provided with interconnected cooling water passageways 106 that are situated in the region of the product mold parting-line perimeter 108 and that are connected to a source of flowing coolant. In some applications the coolant may have a solidification temperature significantly lower than the solidification temperature of water, i.e. significantly lower than 32° Fahrenheit. See FIGS. 7 through 10 for illustration of the location of coolant passageways in proximity to the mold parting-aline perimeter 108.

It should be noted that each end-abutting and double-pivoted gutter plate segment 90, 92, 94 and 96 utilized in the practice of my invention is provided with two pivot axes, each such pivot axis having a longitudinal axis that is transverse (at right angles) to the plane of the product cavity mold parting-line perimeter and that is positioned at or in a different one of the end regions or opposite extremes of the elongated gutter plate segment. In some invention embodiments both pivot axes are movable in directions lying in the plane of the product cavity mold parting-line perimeter. In other invention embodiments, only one such pivot axis of a gutter plate segment is movable relative to the product cavity mold parting-line perimeter, while the other such pivot axis is maintained in a relatively fixed position. The movable pivot axes are moved (powered) by a co-operating bi-directional actuator, and extension and retraction of the actuator piston rod causes the connected gutter plate segment to be rotated about or relative to each of its pivot axes.

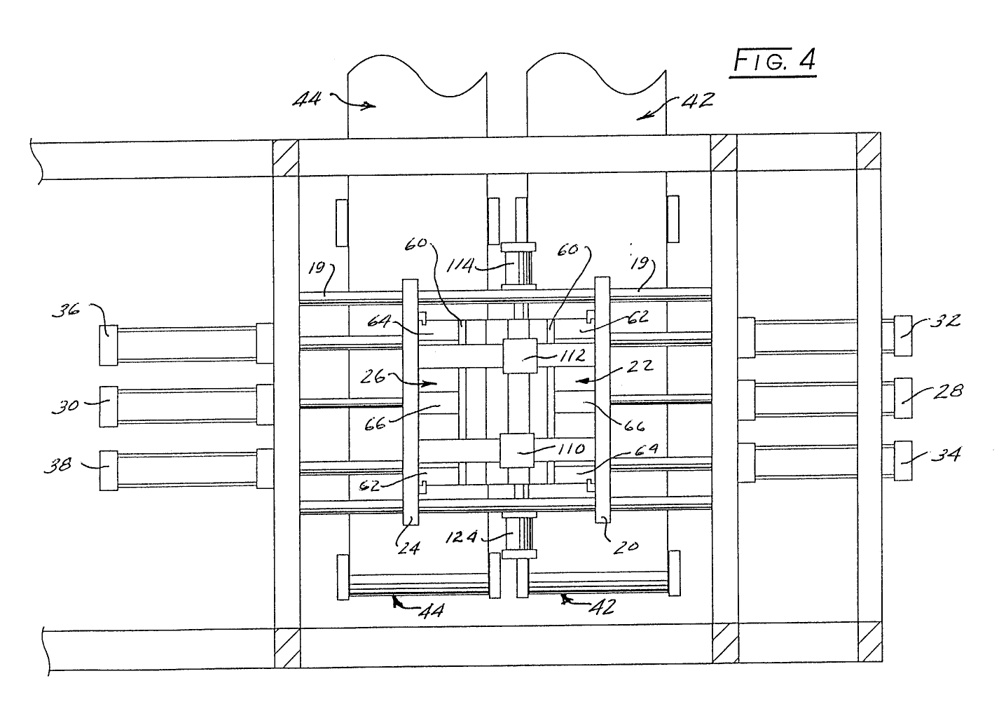

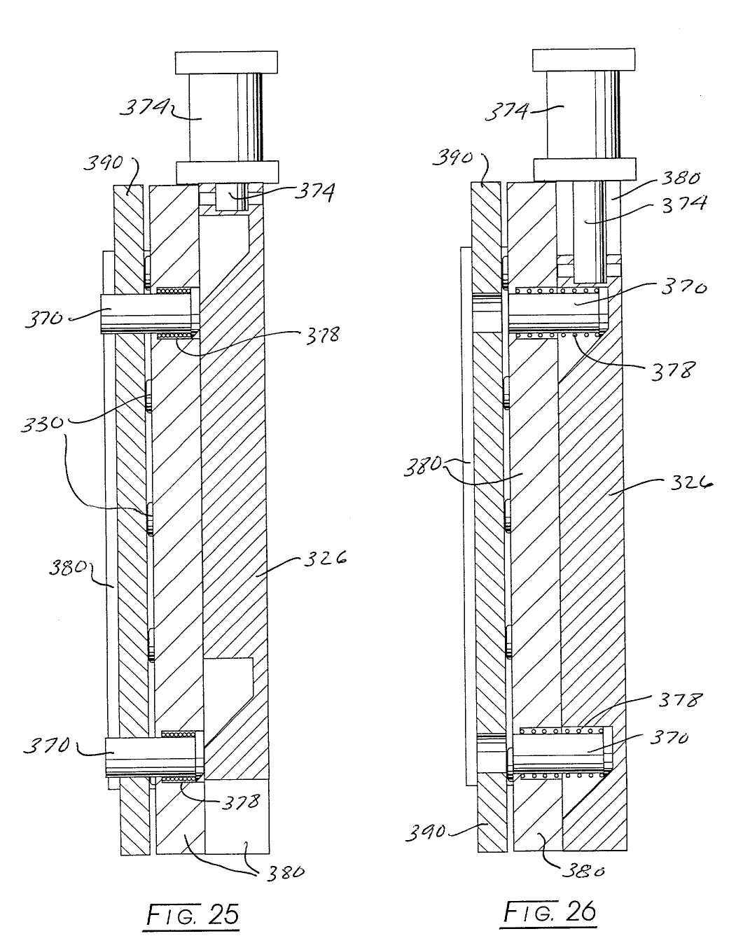

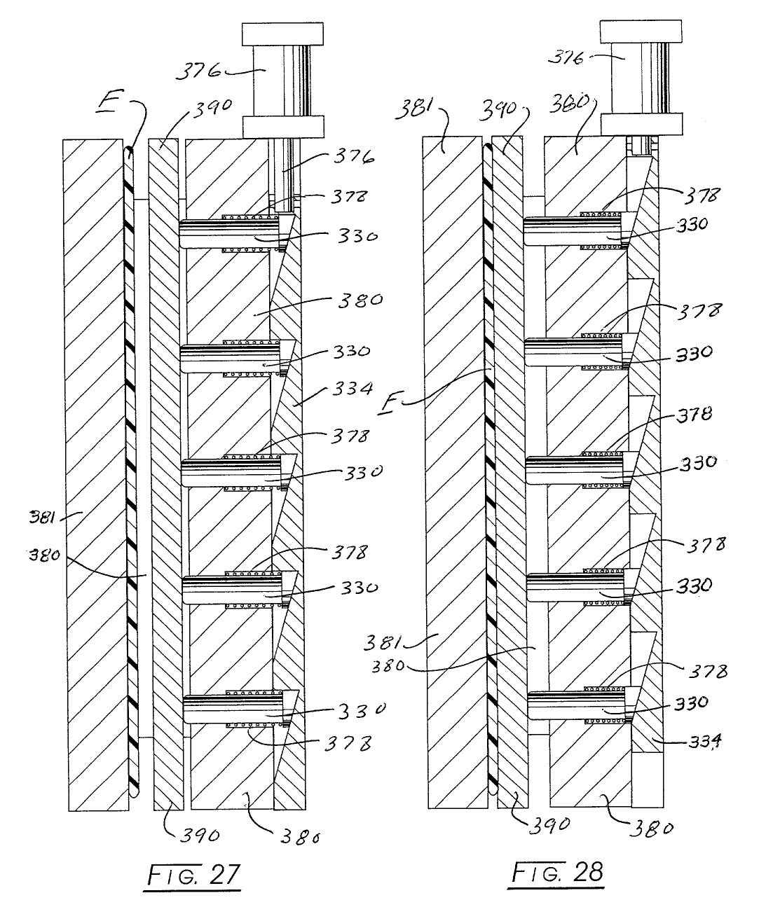

Base blow-mold sub-assembly 22 includes a gutter plate segment drive which in the FIGS. 5 and 6 embodiment is comprised of bi-directional hydraulic actuators 110 through 124 that are each rigidly mounted on structure of sub-assembly 22 and, as shown in detail, the piston rod free end of each such actuator is connected to its respective end region of the adjacent gutter plate segment 90, 92, 94 and 96 by a pivot connection 126 that includes its respective putter plate segment pivot axis. Each such pivot connection preferably is designed to permit the attached gutter plate segment to: (1) primarily be rotated about the pivot axis of the pivot connection for purposes of effecting progressive gutter flash separation from the blow-molded product while the product is fully retained within the assembly product cavity, and (2) secondarily be translated in directions parallel to the pivot axis of the pivot connection for purposes of establishing the desired product wall thickness configuration at the product mold parting line perimeter 108. See FIGS. 7 through 10 and the discussion of FIGS. 15 through 17. A different number of thin shims 128 may be inserted under each bronze wear bushing 130 that supports a gutter plate segment underside bronze wear surface 132, or alternatively, the bronze wear bushings may be extended or retracted using the actuating mechanism discussed in connection with the apparatus particulars of FIGS. 27 and 28. Pivot connections 126 enable the pair of bi-directional hydraulic actuators connected to the opposite or extreme ends of an invention elongated gutter plate segment 90, 92, 94 and 96 having two movable pivot axis to be actuated differentially to effect the progressive separation of integrally attached gutter flash from product P along the product mold parting-line perimeter 108.adjacent the gutter plate segment.

Also, and while not shown in the drawings or suggested elsewhere, other primary power sources such as electric motors combined with various mechanical linkages, devices, and the like may be substituted for bi-directional actuator components 110 through 124 and utilized as the actuators that cause movement of gutter plate segments 90 through 96 relative to the co-operating product molds.

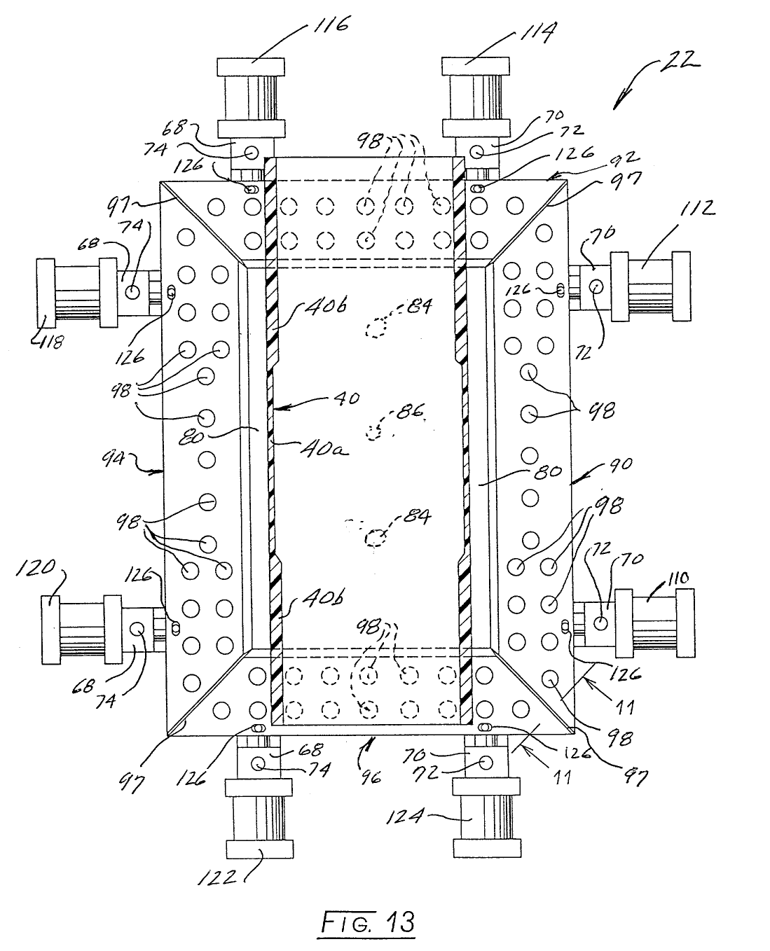

In FIG. 13 I illustrate, in elevation, the gutter plate segment gutter flash clamping surfaces of invention blow-mold assembly 22 as having a different arrangement of tapered, blind-hole recesses that comprise excess gutter flash receiver elements 98 in comparison to the arrangement of FIGS. 5 and 6. Since the descending and superimposed heated tubular parison 40 illustrated in FIG. 13 has programmed sections or zones of reduced thickness 40a and of increased thickness 40b to meet product wall thickness needs, I find it preferable to have added excess gutter flash receiver element 98 capacity in the adjacently situated zones of the gutter plate segments 90, 92, 94, and 96 that surround the product cavity of apparatus product mold half 80 rather than increased receiver element depth. Basically, I strive to have an extent of receiver element surface area or volume provided in the gutter plate segments that generally is directly proportional to the volume (i.e., wall thickness) of thermoplastic resin material in the adjacent zones or sections of the descended heated parison. FIG. 14 schematically illustrates one type of control system that may be utilized in connection with combined blow-mold sub-assemblies 22 and 26 to obtain proper sequencing of the different incorporated pneumatic/hydraulic bi-directional actuators in order to carry out the basic product de-flashing steps of my method invention for the product application of FIGS. 1 through 13. Such control system preferably includes a compressed air source 150, a pressurized hydraulic fluid supply 152 with fluid reservoir 154, and a conventional programmable valve position sequence controller 156 that sequentially activates each of the included conventional 4-way fluid valves 158 to its different valve operating positions and thereby achieve full extension or full retraction of each of the specifically numbered bi-directional actuators connected thereto at the proper time in each production cycle of blow-molding machine 10.

The basic sequence of steps for operating blow-molding machine or system 10, including blow-mold sub-assemblies 22 and 26, for a complete machine production cycle are as follows:

1. Activate machine 10.

2. Retract platens 20 and 24 to fully-separate (open) blow-mold sub-assemblies 22 and 26 (machine function).

3. Cause heated tubular thermoplastic resin parison 40 to descend from die-head 18 to lower edges of assemblies 22 and 26 (machine function).

4. Rapid advance platens 20 and 24 sufficient to engage all crash pads 68 and 70 and thereby fully close blow-mold sub-assemblies 22 and 26 by actuating rapid traverse hydraulic actuators 28 and 30 (machine function).

5. Clamp blow-mold sub-assemblies 22 and 26 together by simultaneously activating hydraulic actuators 32, 34, 36, and 38 (machine function) to engage and contact fully gutter plate segments 90 through 96 with the gutter flash F,. and to flow excess thermoplastic resin parison material into surface reservoirs 98, whereupon accelerated cooling of parison gutter flash material commences.

6. Insert inflation needles 86 into the descended parison contained within mold assemblies 22 and 26.

7. Inject compressed air into contained parison thereby expanding heated parison thermoplastic resin into complete contact with the product cavities 82 of blow-mold sub-assemblies 22 and 26 (machine function) and form thermoplastic resin product P.

8. Activate (retract) bi-directional hydraulic actuators 110, 114, 118, and 122 to pivot gutter plate segments 90, 92, 94, and 96, respectively, thereby separating gutter flash F from blow-molded product P progressively along the product mold parting line perimeter using tension forces.

9. Complete gutter flash separation by activating (retracting) bi-directional hydraulic actuators 112, 116, 120, and 124 to additionally pivot (“rock”) gutter plate to segments 90, 92, 94, and 96, respectively, but in an opposite rotational sense to thereby complete separation of gutter flash F from blow-molded product P progressively along the product mold parting-line perimeter using tension forces.

10. Reverse the actuation of clamping bi-directional hydraulic actuators 32, 34, 36, and 38 (machine function) to release mold assembly clamping pressures.

11. Reverse the actuation direction of bi-directional rapid traverse hydraulic actuator 30 to partially separate and open blow-mold assemblies 22 and 26.

12. Actuate pneumatic bi-directional gutter flash ejectors 100 to separate gutter flash segments F from engagement with the gutter plate segments 90, 92, 94, and 96 of blow-mold sub-assembly 22 for free-fall to the machine flash removal conveyor 44.

13. Reverse the actuation direction of bi-directional rapid traverse hydraulic actuator 28 to fully separate and open blow-mold sub-assemblies 22 and 26.

14. Actuate product ejectors 84 to release product units P from product mold cavities 82 for free-fall to the machine product removal conveyor 42.

15. Extend bi-directional hydraulic actuators 110 through 124 to return gutter plate segments 90, 92, 94, and 96 to their initial position abutting assembly mold 80.

16. Repeat steps 3 through 15 to end of machine production run.

Other arrangements for sequencing the actuation of gutter plate segments 90 through 96 for the separation of gutter flash from product P may be utilized. For instance, bi-directional hydraulic actuators 112, 114, 120, and 122 may be ganged and retracted simultaneously, followed by the retraction of ganged actuators 116, 118, 124, and 110 simultaneously. Also, it is permissible to actuate the different pairs of corner actuators, e.g. 112, 114 and 120, 122 or 116, 118 and 124, 110 either simultaneously or serially. In any event, I prefer to not simultaneously retract both actuators connected to any one of the system gutter plate segments, i.e. I do not retract actuator pairs such as 110/112, 114/116, 118/120, or 122/124 simultaneously.

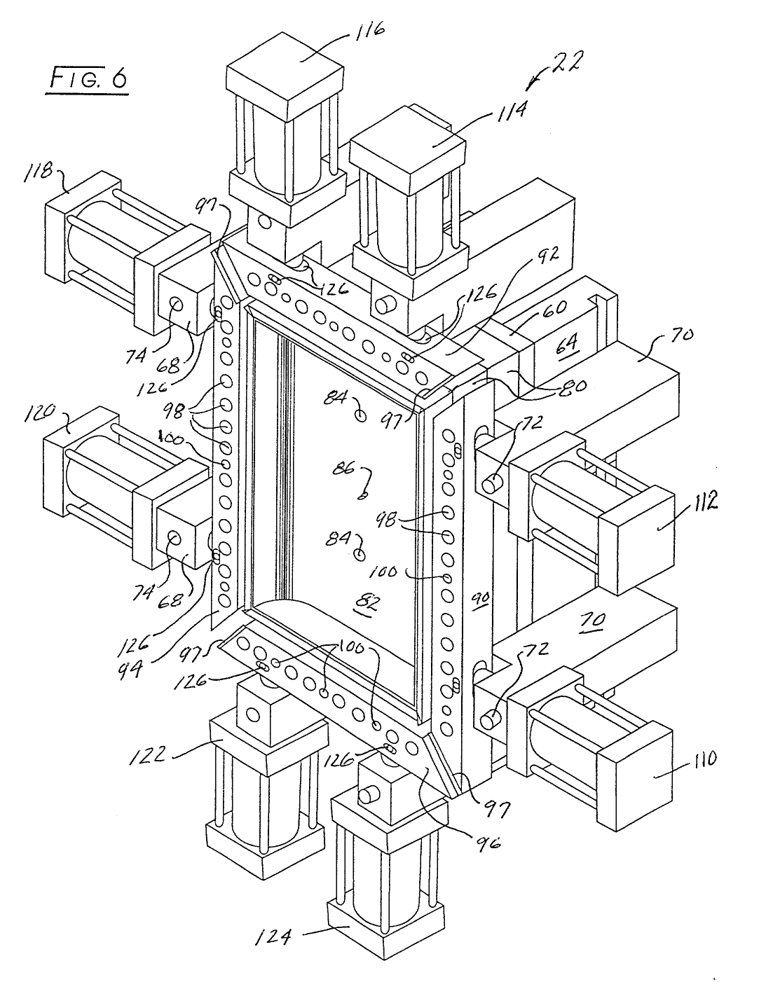

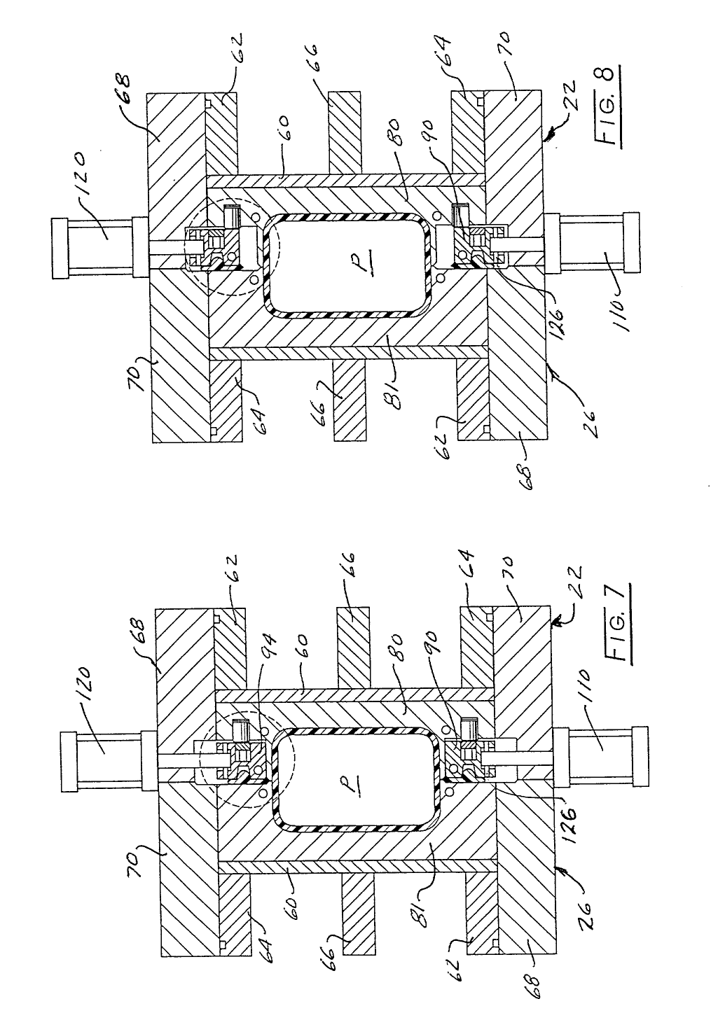

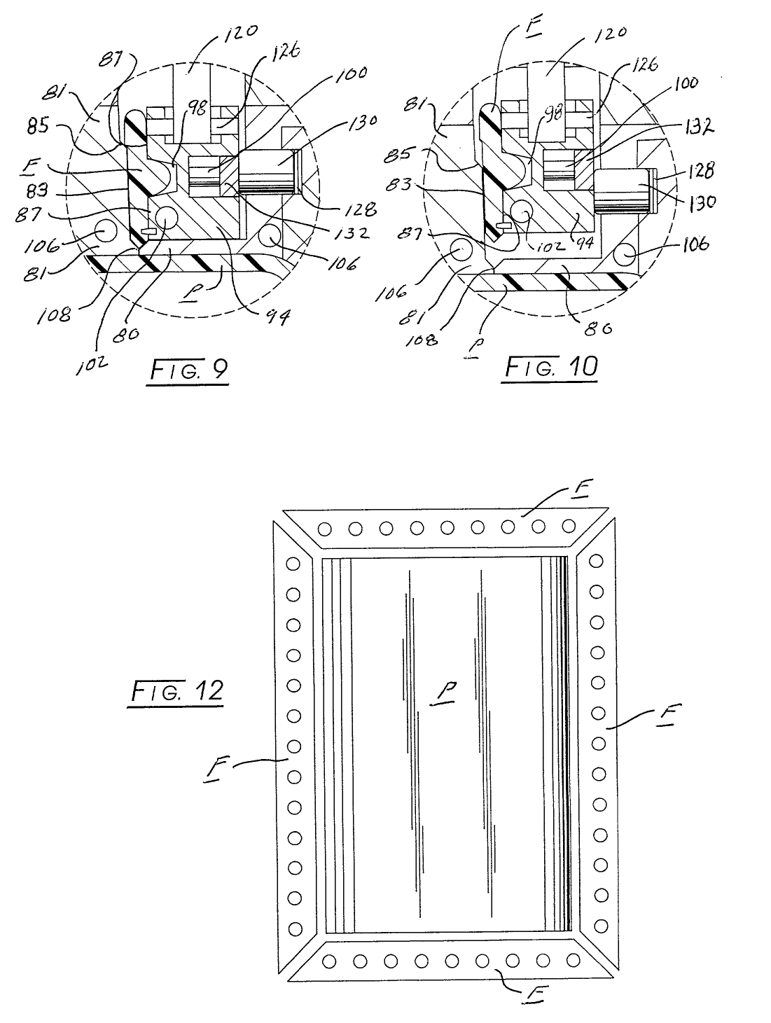

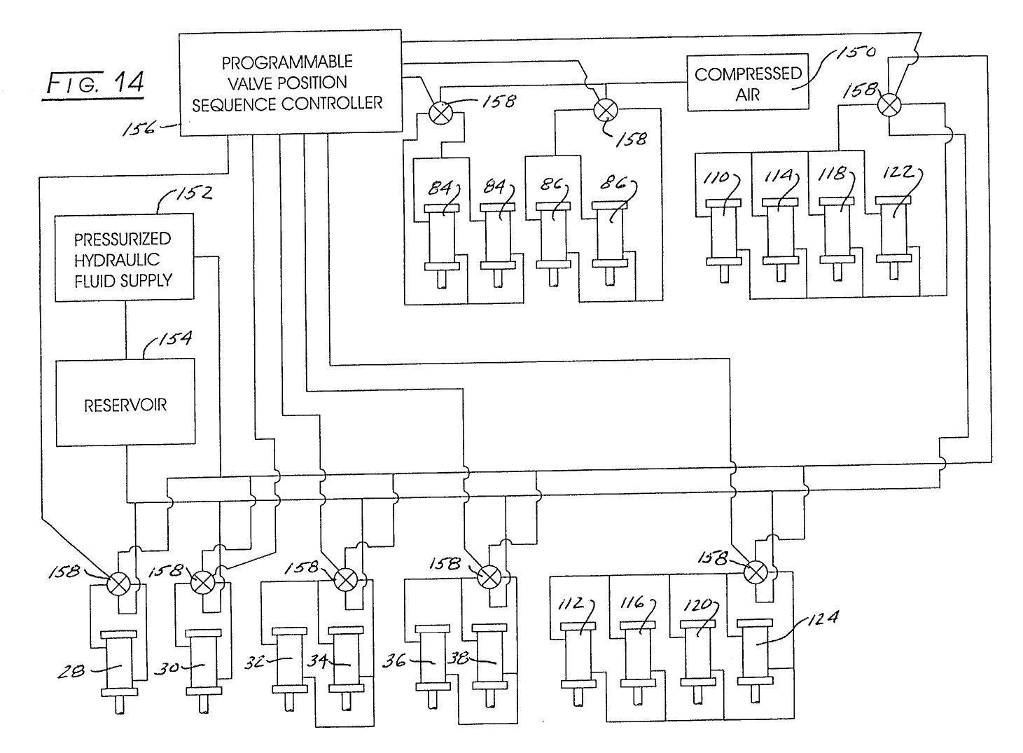

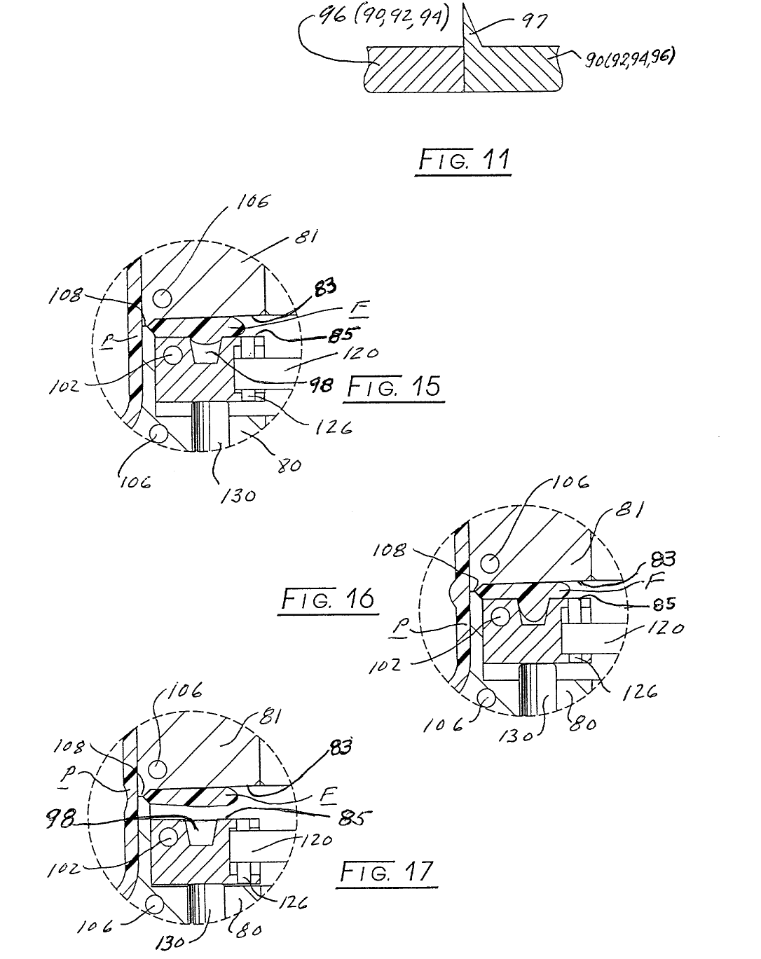

FIGS. 15, 16, and 17 illustrate three different product wall thickness or interior surface configuration conditions that may be obtained in the region of the product mold cavity parting line perimeter using the apparatus of FIGS. 1 through 13. Such are achieved using different combinations of the thickness of shim elements 128 placed beneath bronze wear bushings 130 and the different total extent of excess gutter flash receiver elements 98 surface opening area. See FIGS. 9 and 10. As mentioned above, pivot connections 126 enable gutter plate segments 90, 92, 94 and 96 to move in directions parallel to their pivot axes to change their distances from gutter flash clamping surface 83 of cap blow-mold sub-assembly 26. The product uniform wall thickness condition or configuration of FIG. 15 is nominally uniform and normally preferred, and the required thickness of shim elements 128 is arrived at during initial set-up trial runs of the invention apparatus rather than by arithmetic calculation. If the localized and thickened wall condition shown in FIG. 16 is desired, thereby having an essentially convex interior surface configuration, additional thickness of shim elements 128 may be provided or the area extent of adjacent openings of excess gutter flash receiver elements 98 may be reduced. FIG. 17 illustrates a thinned product wall thickness condition (concave interior surface configuration) at the product mold-cavity parting line perimeter. Such occurs due to either reduced shim thickness under bronze wear bushing elements 130 or an increased adjacent excess gutter flash accumulator element surface area opening capacity. The thinner product wall thickness is often desired in instances where the product is to have an integrally molded and expandable bellows feature, for instance.

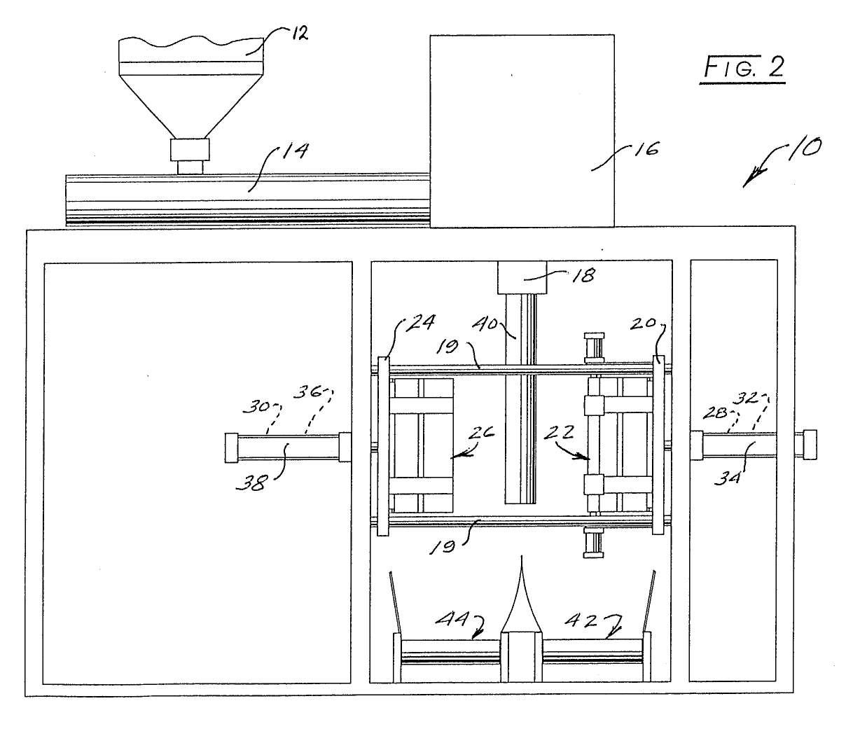

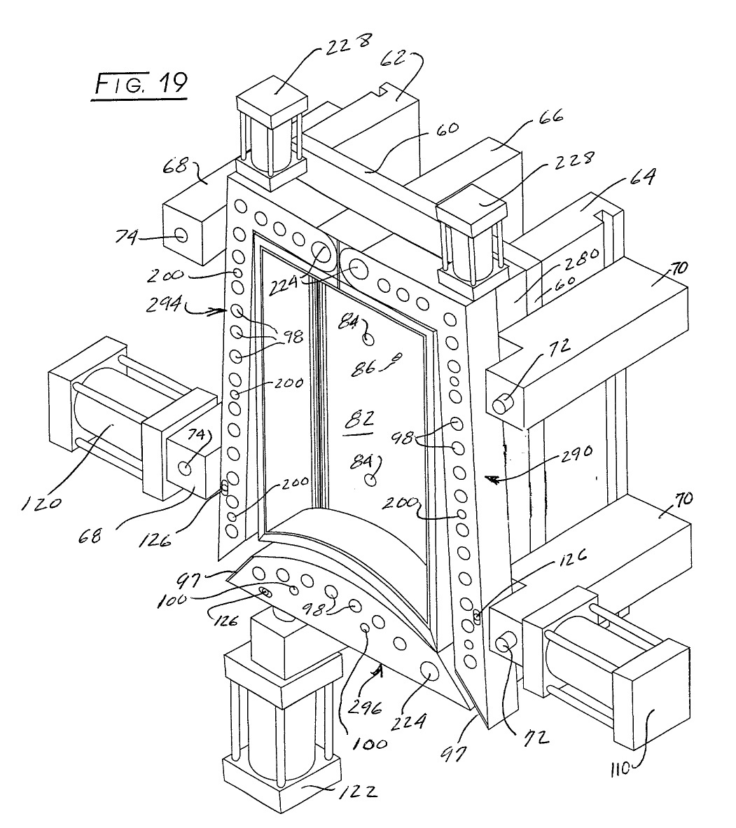

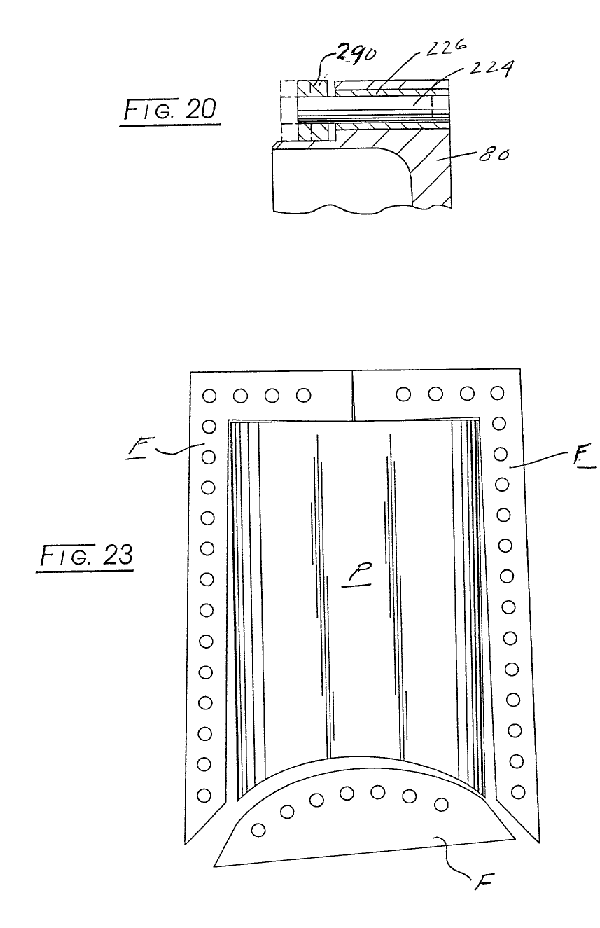

In some blow-molding applications it is desired, because of large product sizes being involved, to remove formed products with partially-attached gutter flash from blow-molding machine 10 as units using overhead take-out conveyor 46 (FIG. 1) rather than product conveyor 42 (FIGS. 2 through 4). In such product applications I utilize the base blow-mold sub-assembly 222 of FIGS. 18 through 22 in preference to the base blow-mold sub-assembly 22 shown in FIGS. 5 and 6. The important differences between such sub-assemblies relate to the use of elongated gutter plate segments 290, 294, and 296 that each have a relatively-fixed pivot axis 224 positioned near or located at one end, and one bi-directional hydraulic actuator, 110, 120, or 122, pivotally attached to a movable pivot axis at the opposite end. Such an arrangement is sometimes preferred over an arrangement wherein each gutter plate segment has two movable pivot axes with pivotally attached bi-directional hydraulic actuator components as shown in FIGS. 5 and 6. Details of fixed pivot 224 and its installation in bronze sleeve bushing 226 in support structure for product mold half 280 are provided in FIG. 20. Note that the position of each gutter plate segment 290, 294, and 296 may be translated in directions normal to the plane of the product mold parting line perimeter by longitudinal sliding movement of fixed pivot 224 within and relative to bronze sleeve bushing 226. This allows the thickness of the gutter flash to be adjusted to thereby set a desired wall thickness characteristic at the product mold cavity parting-line perimeter as discussed above.

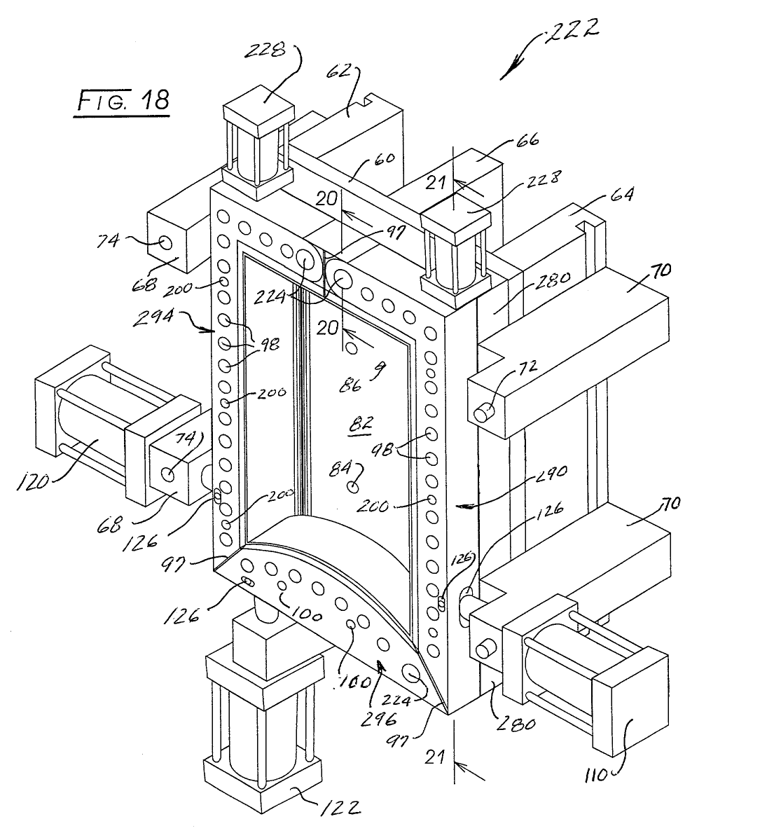

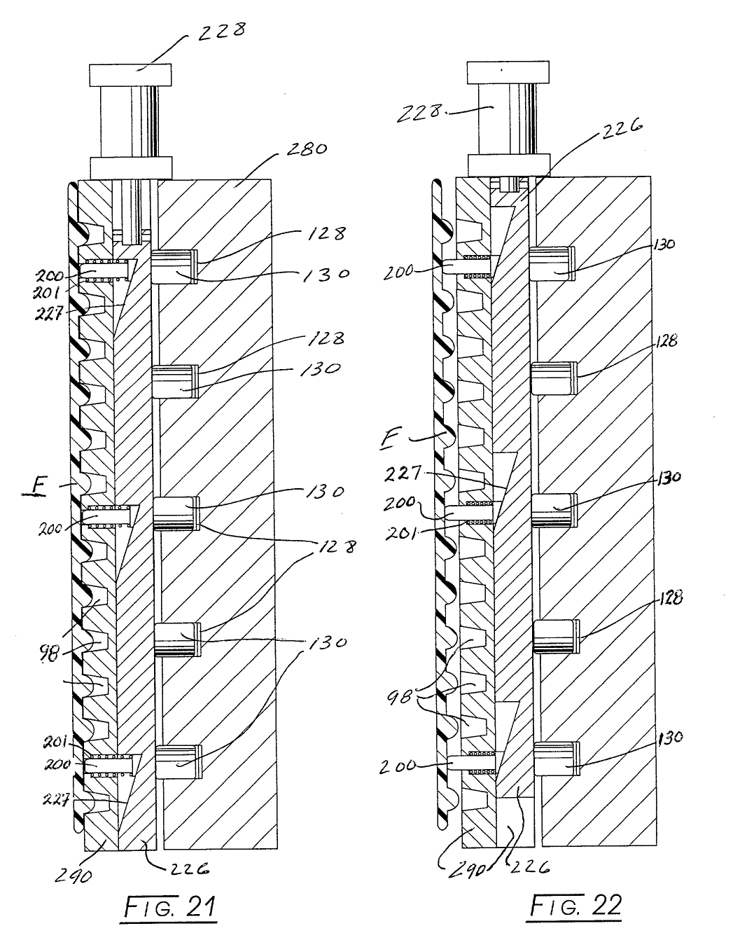

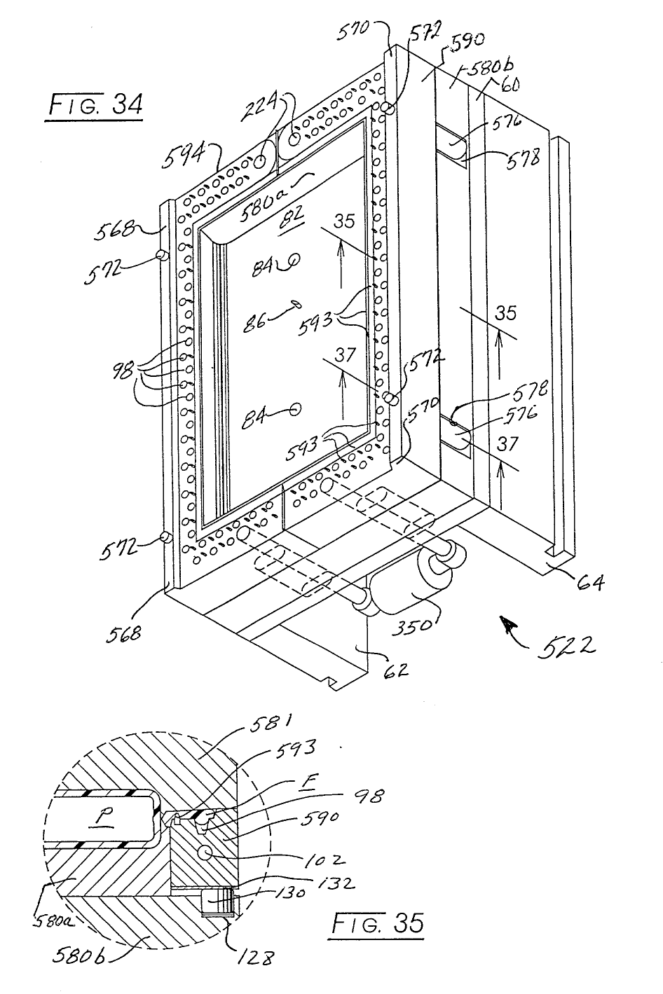

The apparatus of FIGS. 18 and 19 also differs from that of FIGS. 5 and 6 in the use of a different arrangement for actuating gutter flash ejectors. More particularly, and as shown in FIGS. 21 and 22, rather than having an individual bi-directional pneumatic segment for each gutter flash ejector as in the FIGS. 5 and 6 scheme, gutter plate segments 290 and 294 each have an internally-located elongated, multi-ramp slide member 226 that is connected to and powered by bi-directional pneumatic actuator 228 mounted on the gutter plate segment and that cooperates with each individual ejector pin 200. (The respective bi-directional actuators for extending and retracting such ejector pins may be mounted on the undersides of the sub-assembly gutter plate segments and received in adjacent recesses in product mold half 280 in the manner disclosed in connection with the crash pad guide pins of the base blow-mold sub-assembly embodiment of FIGS. 34 through 37). Each ejector pin 200 is spring biased to a retracted position by a spring 201 and has one end which engages a ramp 227 in multi-ramp slide member 226 which causes said ejector pin 200 to move between a retracted position shown in FIG. 21 and an extended position depicted in FIG. 22 when bi-directional pneumatic actuator 228 causes slide member 226 to move between its two extreme positions.

As illustrated in FIG. 23, the molded product P that is produced using sub-assembly 222 retains gutter flash F in an attached condition along a very short segment of the product mold parting-line perimeter located adjacent the apparatus uppermost pivots 224. Such enables the product conveyor 46 (FIG. 1) to grasp the product and gutter flash combination during each production cycle for discharge through access doors 50, such doors being in an fully-opened condition.

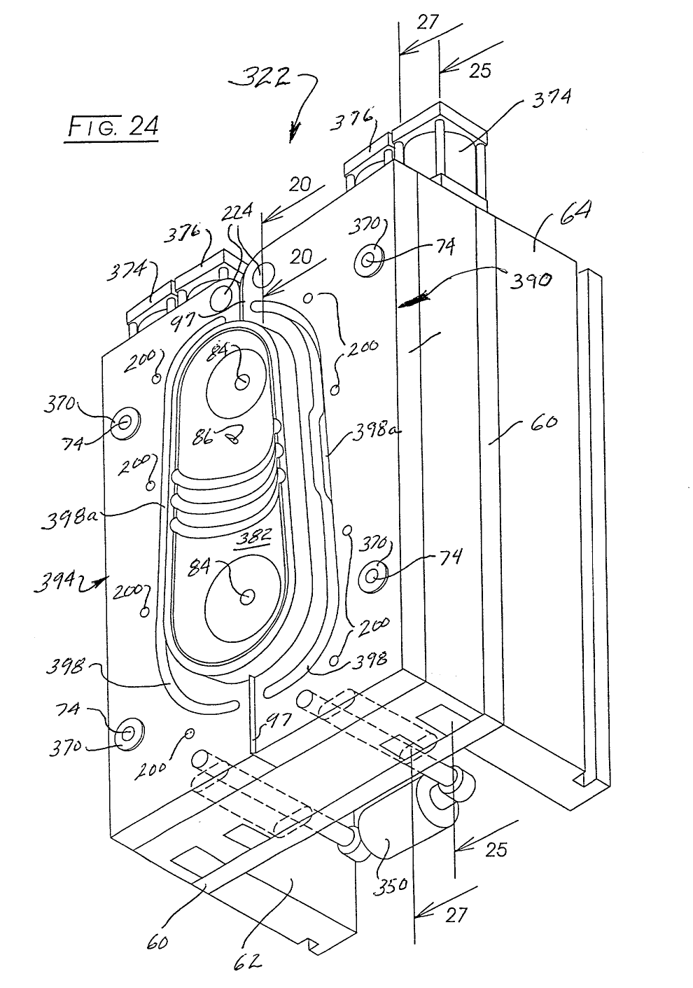

FIGS. 24 through 28 disclose details of a still different embodiment of the blow-molding apparatus of the present invention—an embodiment that is particularly useful in instances wherein blow-molding machine equipment configuration limitations and product size characteristics preclude the installation and use of a base blow-mold sub-assembly having components such as bi-directional hydraulic actuators projecting outwardly from either side of the sub-assembly. The alternate embodiment is designated 322 in the drawings, and basically is comprised of two end-abutting and pivoted gutter plate segments 390 and 394, a bi-directional dual hydraulic gutter plate segment actuator 350, and interiorly-situated internal cylindrical crash pad elements 370 which are reciprocally powered by bi-directional actuators 374. It should be noted that in this embodiment the crash pads 370 project through the gutter plate segments 390 and 394 but may be retracted so as to not subsequently interfere with the pivoting of those gutter plate segments by operation of dual bi-directional actuator 350. These latter actuator elements may be either conventional hydraulic or pneumatic bi-directional actuators and each is connected to a respective, internally-located and elongated, multi-ramp slide member 326 that co-operates with and reciprocally powers their respective reciprocating crash pad elements 370. To assure complete retraction of the crash pad elements from within their respective gutter plate segment upon withdrawal reciprocation of multi-ramp slide member 326 each crash pad element and 370 is surrounded by a compressed return compression spring 378. Each multi-ramp slide member 326 is connected to a bi-directional actuator 374 for reciprocal movement between a crash pad element 370 extended position depicted in FIG. 25 and a crash pad element 370 retracted position depicted in FIG. 26.

Referring to FIGS. 27 and 28, base blow-mold sub-assembly 322 also includes sets of extensible and retractable bronze wear bushing elements 330 that reciprocate within product mold half 380. Such bushing sets co-operate with and are powered by a respective, internally-located and elongated, multi-ramp slide member 334 which in turn is operationally connected to and powered by a respective bi-directional actuator 376 illustrated only in FIGS. 24, 27, and 28. As in the case of crash pad elements 370, each bronze wear bushing element 330 also is provided with a surrounding return compression spring 378. Bronze wear bushing elements 330 when extended set the distance between gutter plate segments 390 and 394 and the gutter flash clamping surface of cap blow-mold sub-assembly mold half 381.

It is important to note that excess gutter flash receiver elements 398 which are included in sub-assembly 322 each have an elongated and tapered blind-slot configuration, and together essentially surround, and are uniformly spaced apart from, the peripheral edges or perimeter of product-defining mold cavity 382. Because the configuration of the product P to be molded using sub-assembly 322 has a central bellows section which requires a comparatively thin product wall thickness, the adjacent excess gutter flash receiver elements 398 each include a centrally situated section 398a that has a substantially increased width and that provides additional adjacent excess gutter flash receiver capacity. See the above discussion of FIG. 17.

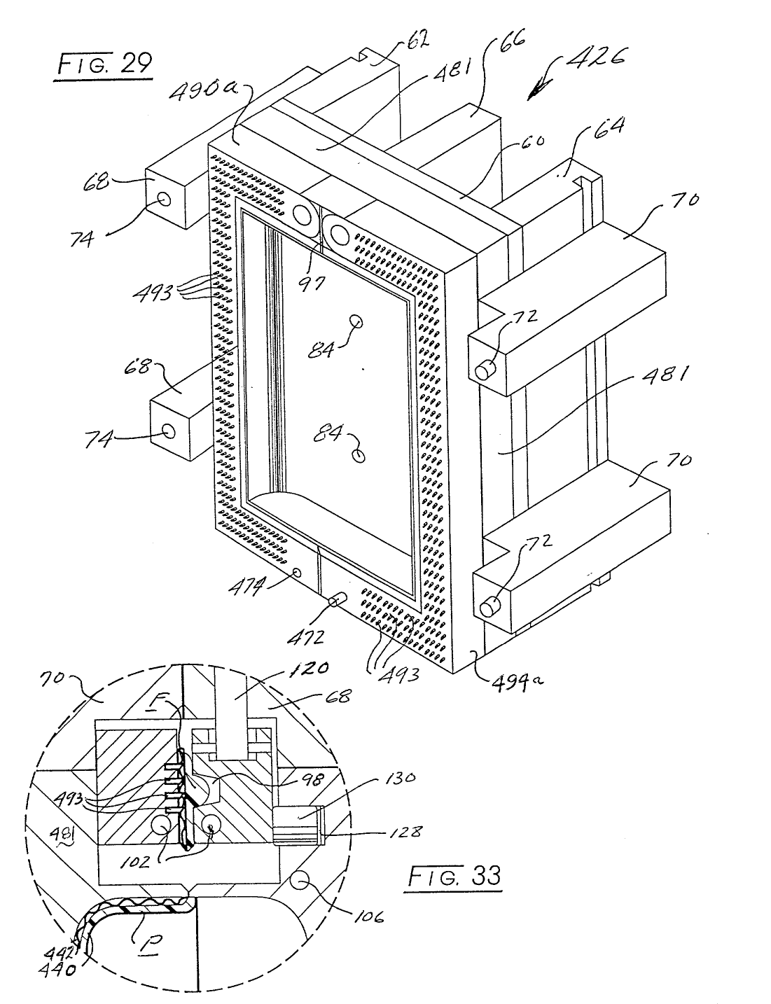

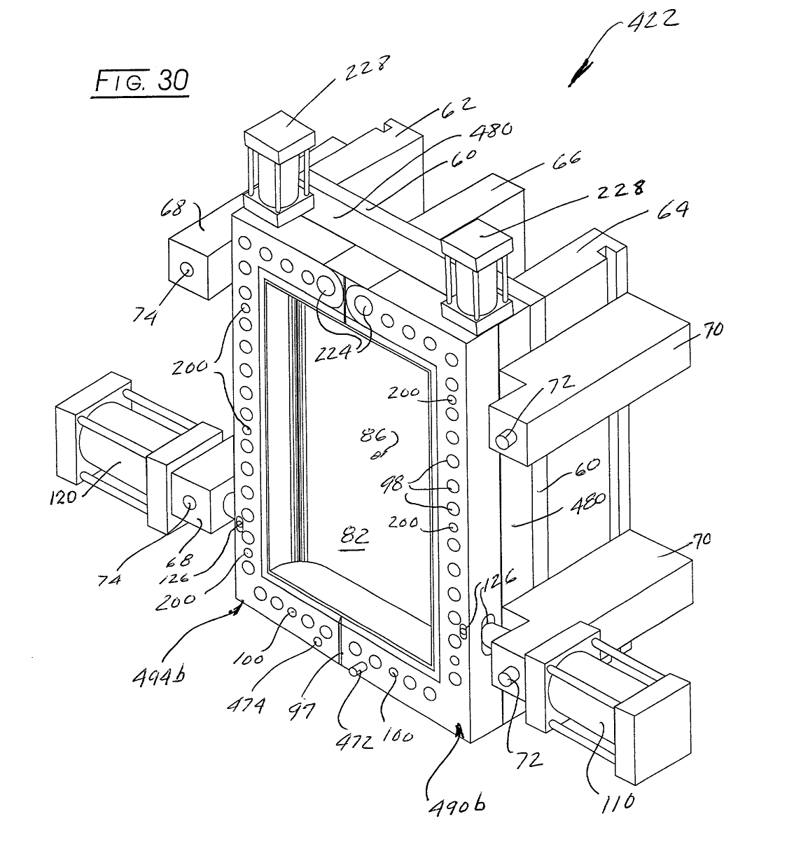

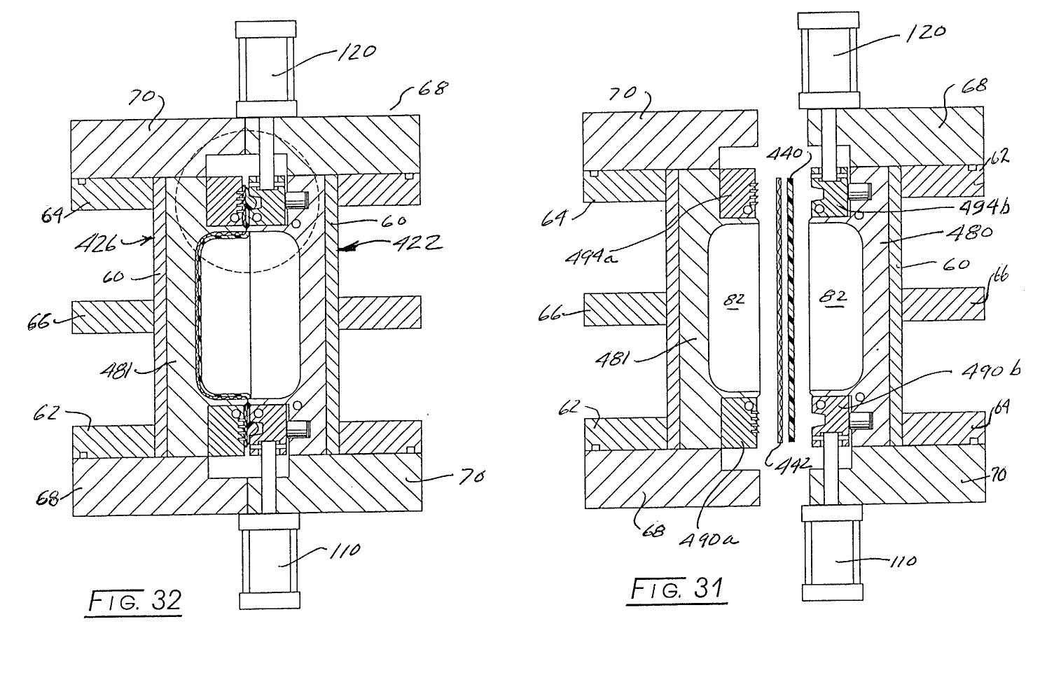

In FIGS. 29 through 33 I illustrate a blow-mold assembly that may be utilized in the blow-molding machine 10 of FIGS. 1 through 4 and that is comprised of base blow-mold sub-assembly 422 depicted in FIG. 30 and cap blow-mold sub-assembly 426 illustrated in FIG. 29. However, rather then be utilized to produce a hollow large, relatively thick-walled thermoplastic resin product, such blow-mold assembly is utilized to form a laminated and contoured product. Such product, also designated as P in FIG. 33, is formed from a sheet-like heated parison 440 of thermoplastic resin material and a sheet-like pliable (i.e., compliant) and stretchable mat 442 of densely randomly-oriented and partially-fused thermoplastic resin fibers. (See FIGS. 31 and 32). The latter material is frequently utilized as a fabric-like surface covering such as in various automotive part applications, e.g. automobile luggage compartment linings, automobile luggage compartment wheel covers, etc.

Cap blow-mold sub-assembly 426 is provided with pivoted and abutting cap gutter plate segments 490a and 494a that each include multiple projecting cleat elements 493 and that each mesh in a unifying sense respectively with gutter plate segments 490b and 494b of base blow-mold sub-assembly 422. Meshing and proper blow-mold sub-assembly alignment upon mold closure is assured by the co-operation of gutter plate segment tapered guide pins 472 with tapered guide pin receptacles 474. Convex projecting cleat elements 493 engage and penetrate into thermoplastic resin mat 442 to retain its edges in a clamped condition during the forming and laminating of product P in the mold assembly fully-closed operating condition.

In the utilization of the blow-mold assembly comprised of sub-assemblies 422 and 426 to produce the laminated product P of FIGS. 32 and 33, compressed air is introduced into the mold cavity 82 from injection needle 86 only after the after the cap and base blow-mold sub-assemblies 426 and 422 have been operationally closed with parison and matting sheets 440 and 442 clamped between co-operating gutter plate segment 490a, 494a, 490b, and 494b. The injected compressed air then causes the sheets of material to conform to the configuration of the product cavity in blow-mold half 481 and to become fused together as a rigid lamination.

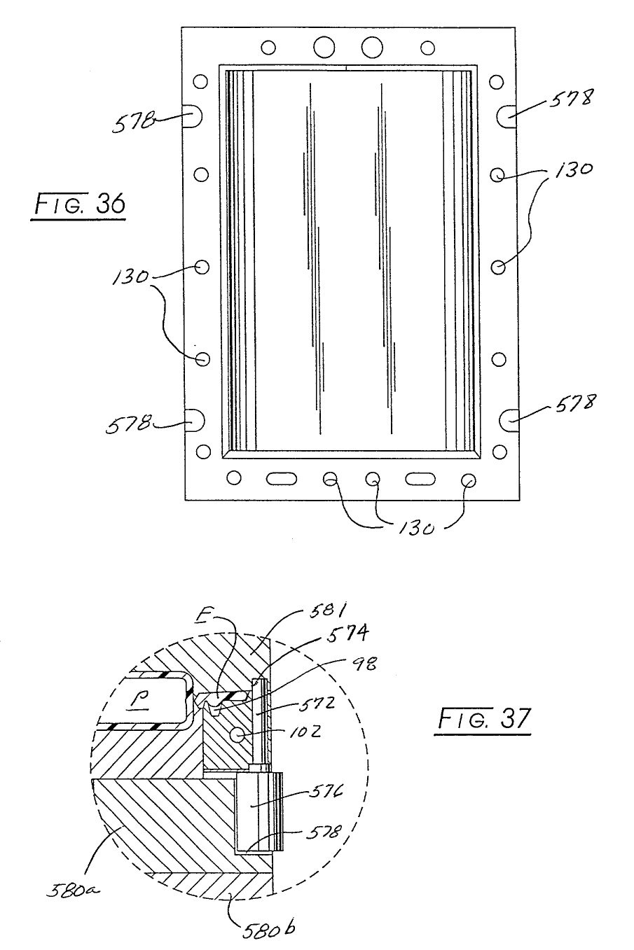

In FIGS. 34 through 37 I illustrate certain details of an embodiment 522 of the invention base blow-mold sub-assembly that, although differing from previously disclosed base blow-mold sub-assembly embodiments, may also be advantageously utilized in the production of large, relatively thick-walled blow-molded thermoplastic resin products. The principal differences of this particular base blow-mold sub-assembly embodiment over the previously described embodiments resides in the fact that the included product mold half is comprised of a relatively shallow conventional mold half 580a that is secured to and carried by a relatively deep mold half support 580b, and in the fact that sub-assembly crash pad elements 570 are formed integral with (i.e., comprise a part of) sub-assembly elongate gutter plate segments 590 and 594. Each elongate gutter plate segment has a pair of tapered guide pins 572 which are each connected to and bi-directionally powered by a conventional bi-directional hydraulic or pneumatic actuator 576 that is attached to the underside of the gutter plate segment and that is situated in a recess 578 provided in the adjacent product mold half 580. Each such guide pin co-operates with a tapered guide pin receptacle or receiver 574 provided in the product mold half 581 of the cap blow-mold sub-assembly that co-operates with sub-assembly 522. See FIG. 37. As in the case of other gutter plate segment embodiments, gutter plate segments 590 and 594 each include multiple spaced-apart and gutter flash-penetrating convex cleat insert element 593 and a multiple spaced-apart blind-hole excess gutter flash material receiver element 98. As an alternative, the elongated excess gutter flash receiver elements 398 of the FIGS. 24 through 28 base blow-mold sub-assembly 322 may be substituted for gutter flash receiver elements 98.

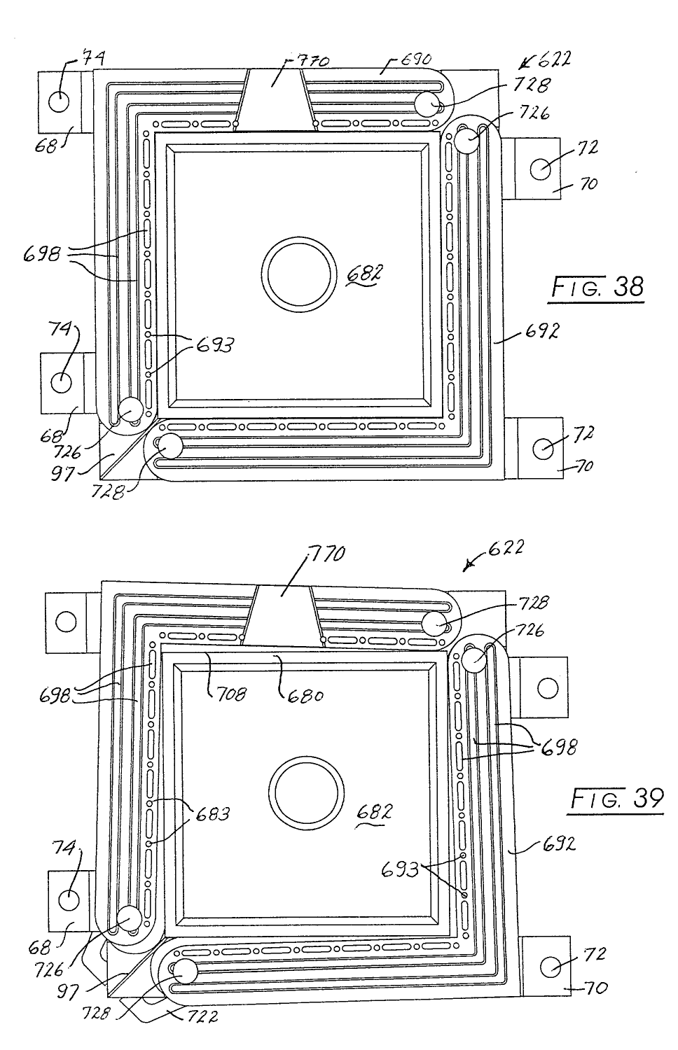

In FIGS. 38 through 42 I illustrate a further embodiment of the base blow-mold sub-assembly of the present invention that my be advantageously utilized in the production of large, thick-walled thermoplastic resin blow-molded products. Such base blow-mold sub-assembly is referenced as 622 and includes product mold half 680 with a product cavity 682 having cavity mold parting-line perimeter 708. Surrounding product cavity mold parting-line perimeter 708 are two, elongate gutter plate segments 690 and 692 which are end-abutted, which each have two transversely-movable pivot pins 726 and 728 and which each are supported on wear blocks 732 as shown in FIG. 42. Each such elongate gutter plate segment also is provided with elongate excess gutter flash receiver elements 698 and with multiple cleat elements 693.

Sub-assembly 622 differs from previously discussed base blow-mold sub-assemblies in several respects. First, sub-assembly 622 is provided with a gutter plate segment relief or undercut zone 770 which facilitates formation of an gutter flash integral take-out tab that may be used advantageously in connection with blow-molding machine operations that employ overhead take-away conveyors such as 46 of FIG. 1. Second, the sub-assembly gutter plate drive is comprised differently than previously discussed gutter plate drives and is located beneath the sub-assembly base plate element 60.

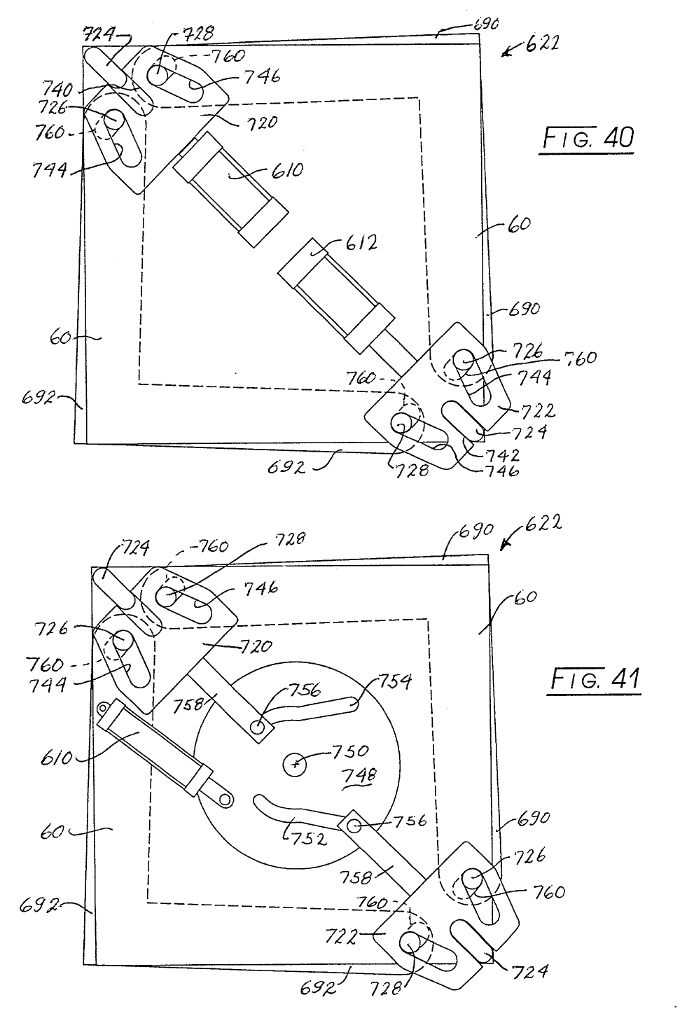

One such gutter plate drive embodiment is illustrated schematically in FIG. 40, and a second embodiment is shown schematically in FIG. 41. The FIG. 40 gutter plate segment drive embodiment is comprised of two, opposite but linearly aligned, double-slotted linear wedge cams 720 and 722 which are each guided linearly by a guide pillar 724 that co-operates with a respective one of wedge cam open-end guide slots 740 or 742, and of two, bi-directional or extendible and retractable actuator devices 610 and 612 that are each connected in driving relation to a respective one of wedge cams 720 and 722. The converging/diverging drive slots 744 and 746 in each wedge cam engage a respective pivot pin 726 or 728. In the FIG. 40 illustration, bi-directional actuator 610 is shown in a retracted condition, and bi-directional actuator 612 is shown in an extended condition. Progressive separation of the integrally attached gutter flash surrounding the blow-molded product is accomplished by the sequential extension of extendible and retractable actuators 610 and 612 whereas in other discussed apparatus embodiments, such as that of FIGS. 5 and 6, the gutter flash separation is accomplished by actuator device retraction.

In the sub-assembly gutter plate segment drive version of FIG. 41, a single pivoted bi-directional or extendible and retractable actuator 610 is advantageously utilized rather than two such devices. In the FIG. 41 scheme, linearly bi-directional actuator 610 drives a double-slotted rotary cam 748 which rotates about axis 750. The rotary cam drive slots 752 and 754 each co-operate with a drive pin 756 carried by connector rod 758, and such slots are developed in a manner whereby rotation of rotary cam 748 causes sequential extension movement of co-operating wedge cams 720 and 722. In the FIG. 41 illustration, double-slotted wedge cam 722 is shown in its extended condition.

Also, in both versions of base blow-mold sub-assembly 622 the gutter plate drive bi-directional actuator devices or bi-directional actuator device and co-operating rotary cam device are basically located at and secured to the underside of the sub-assembly base plate element 60. Four arcuate guide slots 760 are provided in base plate element 60 and function to guide co-operating pivot pins. See FIG. 42. Also, shown in FIG. 42 is elongate bronze-like wear plate element 732 which is carried by base plate element 60 to provide wear support for gutter plate segment 692. Since each sub-assembly gutter plate segment is free to be translated relative to and in directions parallel to the longitudinal axes of pivot pins 726 and 728, the position of the gutter plate segment gutter flash clamping surface relative to the cap blow-mold sub-assembly gutter flash clamping surface may be adjusted to alter product perimeter wall thickness and shape characteristics wall by changing the thickness of wear plate 732 or by changing the thickness of any support shim element provided under that wear plate element. Lastly, the corner filler block 762 which supports transverse gutter flash separator blade 97 may in some applications be advantageously fabricated of a material having low thermal conductivity rather than of metal.

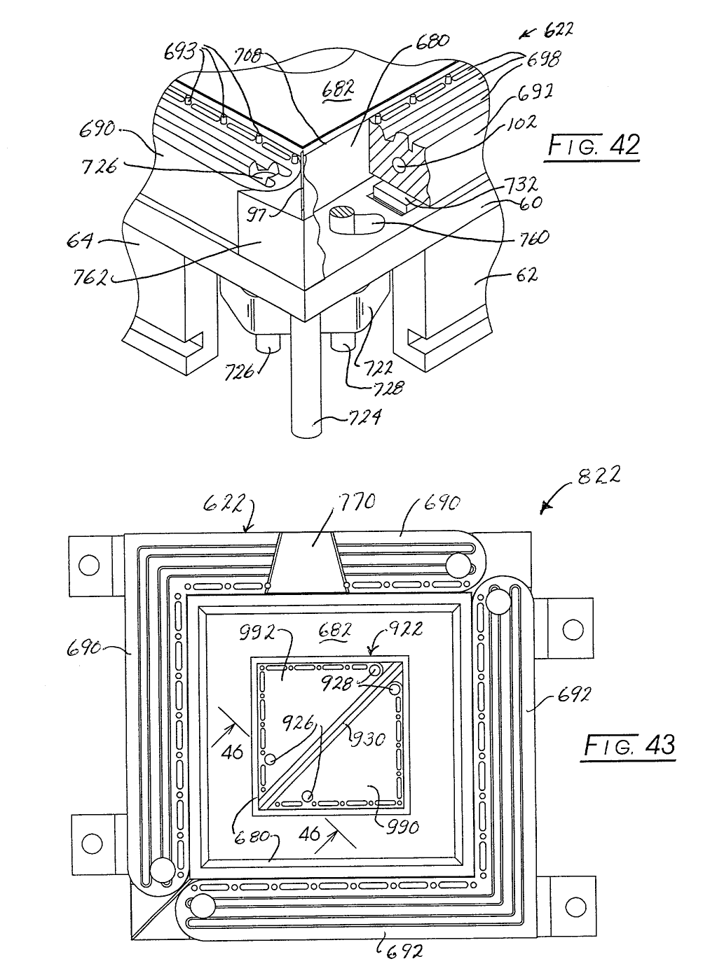

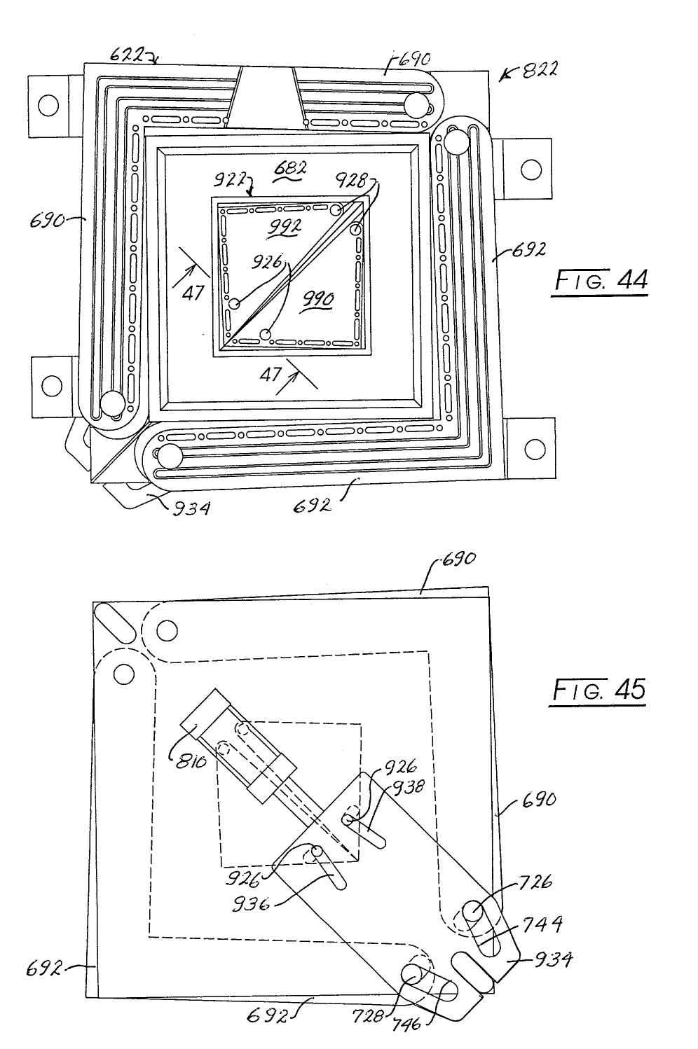

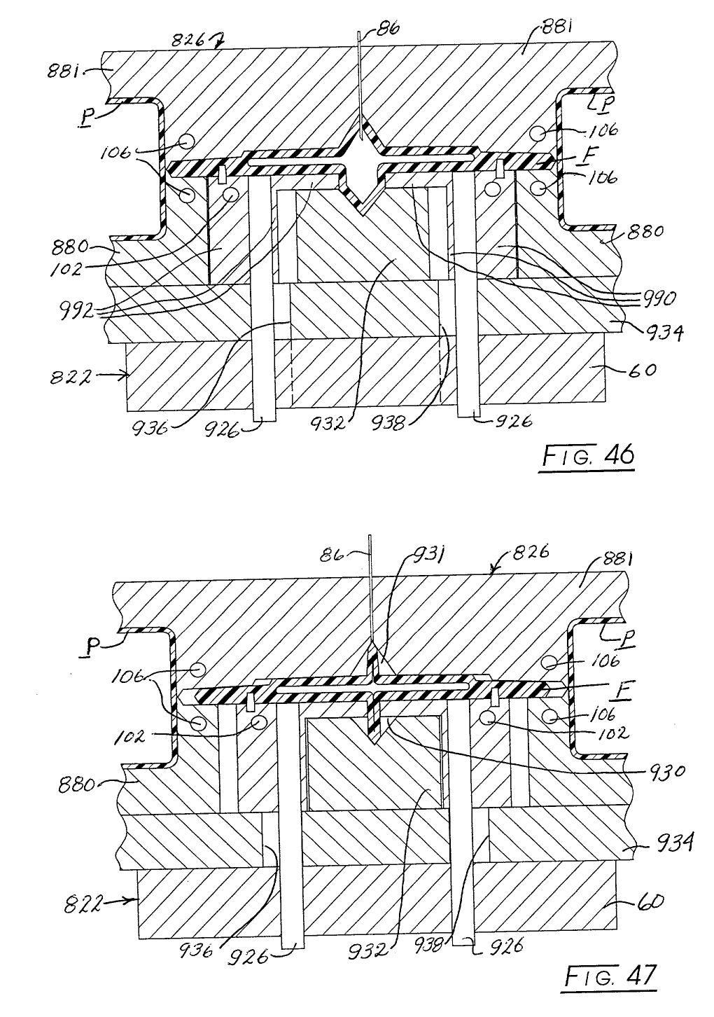

The invention apparatus for separating surrounding integrally-attached gutter flash from a hollow blow-molded product may also be adapted to separate interiorly-situated gutter flash core from the product while the product is retained in its mold cavity. Such is basically accomplished by forming a bellows void in the interiorly-situated gutter flash core using the blow-molding machine compressed air supply, and afterwards progressively collapsing the bellows void using the cooperating interior gutter plate segments provided in the apparatus base blow-mold sub-assembly. The process of collapsing the gutter flash core bellows void causes the interior gutter flash to be progressively separated from the product at its interior mold parting-line perimeter. FIGS. 43 through 47 schematically disclose details of a blow-mold assembly that is may be operated to progressively separate an interior integrally attached gutter flash core from a blow-molded product while the product is retained in the blow-mold assembly. Such blow-mold assembly is comprised of base blow-mold sub-assembly 822 and cap blow-mold sub-assembly 826 (FIGS. 46 and 47). Base blow-mold sub-assembly 822 has essentially the same the product cavity, surrounding elongate and pivoted gutter plate segment, and gutter plate segment drive component construction as that described above in connection with base blow-mold sub-assembly 622 and, accordingly, is therefore identified in the drawings by the same reference numeral. However, sub-assembly 822 additionally includes a core gutter plate sub-assembly 922 that is comprised essentially of triangular interior gutter plate segments 990 and 992, gutter bellows block 932, and an interior gutter plate segment drive. Each such generally triangular interior gutter plate segment 990 and 992 has two pivot pins, 926 and 928. In the FIGS. 43 through 47 base blow-mold sub-assembly 822 scheme, each pivot pin 926 is free to be translated and guided laterally relative to its longitudinal axis during the apparatus core gutter flash separation operation; pivot pins 928 are relatively fixed and remain in their initial position during the gutter flash core separation operation. However, as in the case of base blow-mold sub-assembly 622, all of the included interior gutter plate segment pivot pins may be provided and operated as translatable pivot pins. Also, interior gutter plate segments 990 and 992 essentially fill the interior open area of base blow-mold sub-assembly mold half 880 in their initial operating condition save for the elongated bellows gap that separates those components and that registers with the gutter flash core bellows void cavity 930 provided in included bellows block 932. (See FIG. 46).

The gutter plate segment drive provided in sub-assembly 822 to translatably drive pivot pins 926 and pivot their co-operating interior gutter plate segments 990 and 992 about pivot pins 928 is schematically illustrated in FIG. 45. Such drive utilizes a single bi-directional (extendible and retractable) actuator device 810 which is coupled to a wedge cam element 934 that includes the integral drive slots 744 and 746 for causing pivotal movement of surrounding elongate gutter plate segments 690 and 692 and also added drive slots 936 and 938 for causing pivotal movement of interior gutter plate segment 990 and 992. Integral drive slots 936 and 938 each co-operate with a pivot pin 926 that projects through a respective arcuate guide slot 940 provided in base plate element 60.

Also, and referring to FIGS. 46 and 47, cap blow-mold sub-assembly 826 is distinguished from other herein-disclosed cap blow-mold sub-assemblies in that, like sub-assembly 822, it too includes a gutter flash core bellows void cavity 931, and that cavity registers with the like cavity 930 of base blow-mold sub-assembly 822. Cavity 931 basically is situated between the cap blow-mold sub-assembly stepped gutter flash clamping surfaces 83 that extend away from the product mold parting-line perimeter that defines the edge of the desired product interior through-opening area. Further, sub-assembly 826 also includes a conventional air injector needle 86 that is extended into and later retracted from the interior of bellows void formed by cavities 930 and 931, and that functions to force core gutter flash parison material into complete contact with the surfaces of the co-registered bellows void cavities.

From a method standpoint, and after blow-molding machine 10 drops a heated thermoplastic resin parison to a position between separated blow-mold sub-assemblies 822 and 826 and the blow-mold sub-assemblies are operationally closed, compressed air is injected into the parison interior in parison areas situated in the mold-half product cavity and in the gutter flash core bellows void cavity to expand the parison into contact with the interior surfaces of those cavities. Following product and bellows void formation, exterior gutter plate segments 690 and 692 and interior gutter plate segments 990 and 992 are each pivoted to progressively separate gutter flash from the product along the sub-assembly mold-half product cavity surrounding and interior parting line perimeters. Afterwards the cap and base blow-mold sub-assemblies are operationally opened, and the blow-molded product and the separated surrounding gutter flash and interior gutter flash core are ejected from the blow-mold assembly for subsequent processing.

Various changes may be made to the relative sizes, shapes, materials of construction, and method or procedural steps specifically described above and detailed in connection with FIGS. 1 through 47 of the drawings without departing from the intent, meaning, or scope of the claims which follow.

I claim as my invention:

1. In a method of producing blow-molded thermoplastic resin products that each have a mold parting-line perimeter and that each have the same particularly desired wall thickness configuration characteristic at the product mold parting-line perimeter, and of using: a cap blow-mold sub-assembly having a gutter flash clamping surface extending away from and surrounding the product mold parting-line perimeter; and a co-operating base blow-mold sub-assembly having multiple end-butting and pivoted gutter plate segments which together surround the product mold parting line perimeter and have gutter flash clamping surfaces which oppose and are spaced-apart from the cap blow-mold sub-assembly gutter flash clamping surface, the steps of:
producing a first blow-molded thermoplastic resin product having a wall thickness configuration characteristic at the product mold parting-line perimeter that is different than the particularly desired product wall thickness configuration using the cap blow-mold sub-assembly and the co-operating base blow-mold sub-assembly with a first separation distance separating the cap blow-mold sub-assembly gutter flash clamping surface from the base blow-mold sub-assembly pivoted gutter plate segment gutter flash clamping surfaces;
moving the base blow-mold sub-assembly multiple abutting and pivoted gutter plate segments relative to the cap blow-mold sub-assembly gutter flash clamping surface to thereby change the first separation distance between the gutter plate segment gutter flash clamping surfaces and the cap blow-mold sub-assembly substantially flat gutter flash clamping surface to a second separation distance; and
producing subsequent blow-molded thermoplastic resin products using the cap blow-mold sub-assembly and co-operating base blow-mold sub-assembly with said second separation distance separating the cap blow-mold sub-assembly gutter flash clamping surface from the base blow-mold sub-assembly pivoted gutter plate segment gutter flash clamping surfaces to produce blow-molded thermoplastic resin products that each have the particularly desired wall thickness configuration characteristic at the product mold parting-line perimeter.

2. The method of producing a blow-molded thermoplastic resin product defined by claim 1 wherein the particularly desired wall thickness configuration characteristic at the product mold parting-line perimeter is an interiorly convex wall thickness configuration characteristic, and wherein said second separation distance is less than the first separation distance.

3. The method of producing a blow-molded thermoplastic resin product defined by claim 1 wherein the particularly desired wall thickness configuration characteristic at the product mold parting-line perimeter is an interiorly uniform wall thickness configuration characteristic, and wherein said second separation distance is less than the first separation distance.

4. The method of producing a blow-molded thermoplastic resin product defined by claim 1 wherein the particularly desired wall thickness configuration characteristic at the product mold parting-line perimeter is an interiorly concave wall thickness configuration characteristic, and wherein said second separation distance is greater than the first separation distance.

5. The method of producing a blow-molded thermoplastic resin product defined by claim 1 wherein the particularly desired wall thickness configuration characteristic at the product mold parting-line perimeter is an interiorly uniform wall thickness configuration characteristic, and wherein said second separation distance is equal to the first separation distance.

6. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold assembly, and comprising:
a cap blow-mold sub-assembly having a product cavity that is defined in-part by a cavity mold parting-line perimeter and that is surrounded by a cap blow-mold sub-assembly gutter flash clamping surface extending outwardly from said product cavity mold parting-line perimeter;
a base blow-mold sub-assembly having a support structure, and having a product cavity that is carried by said support structure and that is defined in-part by a cavity mold parting-line perimeter corresponding to said cap blow-mold sub-assembly product cavity mold parting-line perimeter;
multiple base blow-mold sub-assembly elongate gutter plate segments that are each pivotable and movable relative to said base blow-mold sub-assembly support structure, that together surround said base blow-mold sub-assembly product cavity mold parting-line perimeter when end-butted, that each have two, spaced-apart pivot connections each one of which is positioned in a different one of the elongate gutter plate segment end regions, and that each have a gutter flash clamping surface opposing and spaced-apart from said cap blow-mold sub-assembly gutter flash clamping surface; and
multiple bi-directional actuators that are each supported by said base blow-mold sub-assembly support structure, that are each connected to a respective one of said elongate gutter plate segment pivot connections, and that are each actuated to cause pivoting of its respective one of said base elongate gutter plate segments in directions that are parallel to the plane of said base blow-mold sub-assembly product cavity mold parting-line perimeter to separate the integrally attached gutter flash surrounding the product from the product progressively along said base blow-mold assembly product cavity mold parting-line perimeter, said multiple elongate gutter plate segment pivot connections each having a longitudinal pivot axis oriented normal to the plane of said base blow-mold sub-assembly mold parting-line perimeter, and said multiple elongate gutter plate segment pivot connections each permitting its incorporating gutter plate segment to be rotated relative to said base blow-mold sub-assembly product cavity mold parting-line perimeter and to be translated linearly in directions that are parallel to said gutter plate segment pivot connection longitudinal axis.

7. The blow-mold assembly invention defined by claim 6, and wherein said multiple base blow-mold sub-assembly elongate gutter plate segments each have an excess gutter flash receiver element that is recessed in and open relative to the gutter plate segment gutter flash clamping surface.

8. The blow-mold assembly invention defined by claim 6, and wherein said cap blow-mold sub-assembly gutter flash clamping surface comprises a substantially flat and continuous surface extending away from said cap blow-mold sub-assembly product cavity mold parting-line perimeter and with increasing gutter flash clamping surface angular departure away from said multiple elongate gutter plate segment gutter flash clamping surfaces.

9. The blow-mold assembly invention defined by claim 8, and wherein said cap blow-mold sub-assembly substantially flat gutter flash clamping surface increasing surface angular departure is at least approximately a one-degree (1°) or greater departure.

10. The blow-mold assembly invention defined by claim 6, and wherein said cap blow-mold sub-assembly surrounding gutter flash clamping surface comprises an otherwise substantially flat and continuous gutter flash clamping surface that has an intermediate offset step and that extends away from said cap blow-mold sub-assembly product cavity mold parting-line perimeter with increasing gutter flash clamping surface angular departure away from said base blow-mold sub-assembly gutter plate segment gutter flash clamping surfaces.

11. The blow-mold assembly invention defined by claim 6, and further comprising at least one transverse gutter flash separation blade element, one of said base blow-mold sub-assembly gutter plate segments having a transverse gutter flash separation blade element located in one of said gutter plate segment end regions and adjacent an end-abutting gutter plate segment.

12. The blow-mold assembly invention defined by claim 6, and further comprising multiple traverse gutter flash separation blade elements, each said base blow-mold sub-assembly gutter plate segments having at least one of said multiple traverse gutter flash separating blade elements located in at least one gutter plate segment end region and adjacent an end-abutting gutter plate segment.

13. The blow-mold assembly invention defined by claim 7, and wherein said excess gutter flash receiver elements are each comprised of multiple, blind-hole, recesses provided in a respective one of said base blow-mold sub-assembly gutter plate segment gutter flash clamping surfaces.

14. The blow-mold assembly invention defined by claim 7, and wherein said excess gutter flash receiver elements are each comprised of an elongated and continuous blind-slot that is recessed in a respective one of said base blow-mold sub-assembly gutter plate segment gutter flash clamping surfaces.

15. The blow-mold assembly invention defined by claim 13 for use in a blow-molding machine that processes a heated thermoplastic resin parison that has descended parison zones of substantially different wall thickness to form a blow-molded hollow thermoplastic resin product, and wherein said gutter flash receiver element further comprises multiple blind-hole recesses that have a gutter flash clamping surface volume that is generally directly proportional to the wall thickness of the nearest blow-mold machine descended parison zone.

16. The blow-mold assembly invention defined by claim 14 for use in a blow-molding machine that processes a heated thermoplastic resin parison that has descended parison zones of substantially different wall thickness to form a blow-molded hollow thermoplastic resin product, and wherein said gutter flash receiver element further comprises an elongated and continuous blind-slot whose surface opening width and or depth varies generally directly in proportion to the wall thickness of the nearest blow-mold machine descended parison zone.

17. The blow-mold assembly invention defined by claim 6, and wherein said bi-directional actuators comprise an independently-controlled, extendable and retractable actuator, each said independently-controlled, extendable and retractable actuator being connected to a different one of said multiple elongate gutter plate segment pivot connections.

18. The blow-mold assembly invention defined by claim 17, and additionally comprising a programmable sequence controller that is controllably connected to each said extendable and retractable actuator, and that is programmed with respect to each said base blow-mold sub-assembly elongate gutter plate segment to sequentially pivot the base blow-mold sub-assembly elongate gutter plate segment first about one of its said two pivot connections and afterwards about the other of its said two pivot connections.

19. The blow-mold assembly invention defined by claim 6, further comprising at least one coolant passage formed in said elongate gutter plate segments adjacent said product cavity mold parting-line perimeter.

20. The blow-mold assembly invention defined by claim 6, further comprising a recessed section formed in one of said cap blow-mold sub-assembly gutter flash clamping surface or said gutter plate segment gutter flash clamping surface to provide a section of gutter flash attached to said product.

21. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold sub-assembly, and comprising:
a cap blow-mold sub-assembly having a product cavity that is defined in-part by a mold parting-line perimeter, and that is surrounded by a cap blow-mold sub-assembly gutter flash clamping surface extending outwardly from said product cavity mold parting-line perimeter;
a base blow-mold sub-assembly having a support structure, and having a product cavity that is carried by said support structure and that is defined in-part by a mold parting-line perimeter corresponding to said cap blow-mold sub-assembly product cavity mold parting-line perimeter;
multiple base blow-mold sub-assembly elongate gutter plate segments that are each pivotable and movable relative to said base blow-mold sub-assembly support structure, that together surround said base blow-mold sub-assembly product cavity mold parting-line perimeter when end-abutted, that each have two, spaced-apart pivot connections each of which is positioned in a different one of the elongate gutter plate segment end regions, that each have a gutter flash clamping surface opposing and spaced-apart from said cap blow-mold sub-assembly gutter flash clamping surface;
a controlled bi-directional gutter plate segment drive that is actuated to cause pivoting of each said elongate gutter plate segments in directions away from said base blow-mold sub-assembly product cavity mold parting-line perimeter to separate the product surrounding gutter flash from the product progressively along said base blow-mold sub-assembly product cavity mold parting line perimeter, said multiple elongate gutter plate segment pivot connections each having a longitudinal pivot axis oriented normal to the plane of said base blow-mold sub-assembly mold parting-line perimeter, said two pivot connections in each elongate gutter plate segment each permitting its incorporating elongate gutter plate segment to be translated linearly in directions that are parallel to said gutter plate segment pivot connection longitudinal axis, one of said two pivot connections in each elongate gutter plate segment being translatable linearly and the other of said two pivot connections in each elongate gutter plate segment being non-translatable linearly in directions that are parallel to the plane of said base blow-mold sub-assembly product cavity mold parting line perimeter, and said controlled bi-directional gutter plate segment drive being operably connected only to those of said multiple elongate gutter plate segment two pivot connections which are translatable linearly in directions that are parallel to the plane of said base blow-mold sub-assembly product cavity mold parting-line perimeter.

22. The blow-mold assembly invention defined by claim 21, and wherein said cap blow-mold sub-assembly gutter flash clamping surface comprises a substantially flat and continuous gutter flash clamping surface extending outwardly away from said cap blow-mold sub-assembly product cavity mold parting-line perimeter with increasing gutter flash clamping surface angular departure away from said elongate gutter plate segment gutter flash clamping surfaces.

23. The apparatus invention defined by claim 22, and wherein said cap blow-mold sub-assembly substantially flat gutter flash clamping surface increasing surface angular departure is at least approximately one degree (1°) or greater.

24. The apparatus invention defined by claim 21, and wherein said cap blow-mold sub-assembly gutter flash clamping surface comprises an otherwise substantially flat and continuous gutter flash clamping surface that has an intermediate offset step and that extends away from said cap blow-mold sub-assembly product cavity mold parting-line perimeter with increasing gutter flash clamping surface angular departure away from said multiple elongate gutter plate segment gutter flash clamping surfaces.

25. The blow-mold assembly invention defined by claim 21, and further comprising at least one transverse gutter flash separation blade element, one of said base blow-mold sub-assembly end-abutting gutter plate segments having a transverse gutter flash separation blade element located in an end region that is adjacent the end region of another of said elongate gutter plate segments.

26. The blow-mold assembly invention defined by claim 21, and wherein said multiple base blow-mold sub-assembly elongate gutter plate segments each have an excess gutter flash receiver element that is recessed in and open relative to the gutter plate segment gutter flash clamping surface.

27. The blow-mold assembly invention defined by claim 26, and wherein said elongate gutter plate segment excess gutter flash receiver elements are each comprised of multiple blind-hole recesses provided in a respective one of said base blow-mold sub-assembly gutter plate segment gutter flash clamping surfaces.

28. The blow-mold assembly invention defined by claim 26, and wherein said elongate gutter plate segment excess gutter flash receiver elements are each comprised of an elongate and continuous blind-slot that is recessed in a respective one of said base blow-mold sub-assembly gutter plate segment gutter flash clamping surfaces.

29. The blow-mold assembly invention defined by claim 28, wherein said elongate gutter plate segment excess gutter flash receiver elements have a surface opening configuration that is uniformly spaced-apart from and parallels the configuration of the adjacent portion of said base blow-mold sub-assembly product cavity mold parting-line perimeter.

30. The blow-mold assembly invention defined by claim 26 for use in a blow-molding as machine that processes a heated thermoplastic resin parison that has descended parison zones of substantially different wall thickness to form a blow-molded hollow thermoplastic resin product, and wherein said elongate gutter plate excess gutter flash receiver elements each further comprise multiple blind-hole recesses that have a gutter flash clamping surface volume that varies generally directly in proportion to the wall thickness of the nearest blow-mold machine descended parison zone.

31. The blow-mold assembly invention defined by claim 26 for use in a blow-molding machine that processes a heated thermoplastic resin parison that has descended parison zones of substantially different wall thickness to form a blow-molded hollow thermoplastic resin product, and wherein said elongate gutter plate segment excess gutter flash receiver elements each further comprises an elongated and continuous blind-slot whose surface opening width and or depth varies generally directly in proportion to the wall thickness of the nearest blow-mold machine descended parison zone.

32. The blow-mold assembly invention defined by claim 21, further comprising at least one coolant passage formed in said elongate gutter plate segments adjacent said product cavity mold parting-line perimeter.

33. The blow-mold assembly invention defined by claim 21, further comprising a recessed section formed in one of said cap blow-mold sub-assembly gutter flash clamping surface or said gutter plate segment gutter flash clamping surface to provide a section of gutter flash attached to said product.

34. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold assembly, and comprising:
a cap blow-mold sub-assembly having support structure, and having a product cavity that is carried by said cap blow-mold sub-assembly support structure and that is defined in-part by a mold parting-line perimeter;
multiple cap blow-mold sub-assembly elongate gutter plate segments that are each pivotally connected and movable relative to said cap blow-mold sub-assembly support structure, that together surround said cap blow-mold sub-assembly product cavity mold parting-line perimeter when end-abutted, that each have a gutter flash clamping surface extending outwardly and away from said cap blow-mold sub-assembly product cavity mold parting-line perimeter; and that each have multiple convex or concave cleat elements;
a base blow-mold sub-assembly having support structure, and having a product cavity that is carried by said base blow-mold sub-assembly support structure and that is defined in-part by a cavity mold parting-line perimeter corresponding to said cap blow-mold sub-assembly product cavity mold parting-line perimeter;
multiple base blow-mold sub-assembly elongate gutter plate segments that are each pivotally connected and movable relative to said base blow-mold sub-assembly support structure, that together completely surround said base blow-mold sub-assembly product cavity mold parting-line perimeter when end-butted, that each have two, spaced-apart pivot connections each one of which is positioned in a different one of the elongate gutter plate segment end regions, that each have a gutter flash clamping surface opposing and spaced-apart from a respective one of said cap blow-mold sub-assembly elongate gutter plate segment gutter flash clamping surfaces,
a bi-directional gutter plate segment drive carried by said base blow-mold assembly support structure and co-operably connected to said multiple base blow-mold sub-assembly elongate gutter plate segments; and
guide pin elements provided in one of said cap blow-mold assembly multiple elongate gutter plate segments and said base blow-mold sub-assembly multiple elongate gutter plate segments; and
guide pin receptacle elements provided in the other of said cap blow-mold assembly multiple elongate gutter plate segments and said base blow-mold sub-assembly multiple elongate gutter plate segments and co-operating with said guide pin elements, said co-operating guide pin and guide pin receptacle elements causing said cap blow-mold sub-assembly multiple elongate gutter plate segments and said base blow-mold sub-assembly multiple elongate gutter plate segments to be pivoted simultaneously when said bi-directional gutter plate segment drive is actuated to pivot said base blow-mold sub-assembly multiple abutting gutter plate segments and thereby progressively separate integrally attached gutter flash from the product.

35. The blow-mold assembly invention defined by claim 34, and further comprising at least one bi-directionally movable product ejector element and at least one bi-directionally movable air injection needle element, said bi-directionally movable air injection needle element being extendable into and retractable from one of said cap and base blow-mold sub-assembly product cavities, and said bi-directionally movable product ejector elements being extendable into and retractable from one of said cap and base blow-mold sub-assembly product cavities.

36. The blow-mold assembly invention defined by claim 34, and wherein said cap blow-mold sub-assembly elongate gutter plate segment gutter flash clamping surfaces each comprise a substantially flat and continuous surface extending outwardly from said cap blow-mold sub-assembly product cavity mold parting-line perimeter and with increasing gutter flash clamping surface departure away from said base blow-mold sub-assembly gutter plate segment gutter flash clamping surfaces.

37. The blow-mold assembly invention defined by claim 36, and wherein said cap blow-mold sub-assembly substantially flat gutter flash clamping surface increasing surface departure is at least approximately a one-degree (1°) or greater departure.

38. The blow-mold assembly invention defined by claim 34, further comprising an excess gutter flash receiver element that is recessed in and open relative to one of said cap or said base blow-mold sub-assembly gutter plate segment gutter flash clamping surfaces.

39. The blow-mold assembly invention defined by claim 34, further comprising cleat elements projecting convexly from or concavely into one of said cap or said base blow-mold sub-assembly gutter plate segment gutter flash clamping surfaces.

40. The blow-mold assembly invention defined by claim 34, and wherein each said cap blow-mold sub-assembly gutter plate segment gutter flash clamping surface comprises an otherwise substantially flat and continuous gutter flash clamping surface that has an intermediate offset step and that extends away from said cap blow-mold sub-assembly product cavity mold parting-line perimeter with increasing gutter flash clamping surface departure away from said base blow-mold sub-assembly gutter plate segment gutter flash clamping surfaces.

41. The blow-mold assembly invention defined by claim 34 further comprising coolant passages formed in said elongate gutter plate segments adjacent said product cavity mold parting-line perimeter.

42. The blow-mold assembly invention defined by claim 34 further comprising a recessed section formed in one of said cap blow-mold sub-assembly gutter flash clamping surface or said gutter plate segment gutter flash clamping surface to provide a section of gutter flash attached to said product.

43. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold assembly, comprising:
a cap blow-mold sub-assembly having a product cavity that is defined in-part by a cavity mold parting-line perimeter, and that is surrounded by a cap blow-mold sub-assembly gutter flash clamping surface extending outwardly from said cap blow-mold sub-assembly product cavity mold parting-line perimeter;
a base blow-mold sub-assembly having a support structure, and having a product cavity defined in-part by a cavity mold parting-line perimeter corresponding to said cap blow-mold sub-assembly product cavity mold parting-line perimeter;
multiple elongate gutter plate segments that are each pivotally connected to and supported by said base blow-mold sub-assembly support structure, that together surround said base blow-mold sub-assembly product cavity mold parting-line perimeter when abutted, that each have a pivot connection near each gutter plate segment end region, that each have a gutter flash clamping surface extending outwardly from said base blow-mold sub-assembly product cavity mold parting-line perimeter; and
crash pad element formed integrally with said multiple elongate gutter plate segments, projecting from said elongate gutter plate segment gutter flash clamping surfaces toward said cap blow-mold sub-assembly gutter flash clamping surface, and spaced-apart from each other at opposed sides of said base blow-mold sub-assembly by a distance which exceeds the width of said mold cavity;
said multiple crash pad elements each contacting said cap blow-mold sub-assembly gutter flash clamping surface to establish the desired separation between said cap and base blow-mold sub-assembly product cavity mold parting line perimeters when said base and cap blow-mold sub-assemblies are operationally closed, thereby determining the thickness of gutter flash surrounding said base and cap blow-mold sub-assembly product cavity mold parting-line perimeters and further determining the wall thickness and the interior surface configuration characteristic of the product at the product mold parting-line perimeter.

44. The blow-mold assembly invention defined by claim 43, further comprising an excess gutter flash receiver element formed in said elongate gutter plate segments.

45. The blow-mold assembly invention defined by claim 44, and wherein said excess gutter flash receiver elements are each comprised of multiple blind-hole recesses provided in a respective one of said base blow-mold sub-assembly gutter plate segment gutter flash clamping surfaces.

46. The blow-mold assembly invention defined by claim 44, and wherein said excess gutter flash receiver elements are each comprised of an elongated and continuous blind-slot that is recessed in a respective one of said base blow-mold sub-assembly gutter plate segment gutter flash clamping surfaces.

47. The blow-mold assembly invention defined by claim 44 for use in a blow-molding machine that processes a heated thermoplastic resin parison that has descended parison zones of substantially different wall thickness to form a blow-molded hollow thermoplastic resin product, and wherein said gutter flash receiver elements each further comprise multiple blind-hole recesses that have a gutter plate segment gutter flash clamping surface volume that varies generally directly in proportion to the wall thickness of the nearest blow-mold machine descended parison zone.

48. The blow-mold assembly invention of claim 44 for use in a blow-molding machine that processes a heated thermoplastic resin parison that has descended parison zones of substantially different wall thickness to form a blow-molded hollow thermoplastic resin product, and wherein said gutter flash receiver elements each further comprise an elongated and continuous blind-slot whose surface opening width and or depth varies generally directly in proportion to the wall thickness of the nearest blow-mold machine descended parison zone.

49. The blow-mold assembly invention defined by claim 43, wherein said cap blow-mold sub-assembly is further comprised of guide pin receiver elements located in said cap blow-mold sub-assembly gutter flash clamping surface, and wherein said elongate gutter plate segments are each further comprised of extendable and retractable guide pin elements, said extendable and retractable guide pin elements each projecting through an integrally formed crash pad element and into cooperation with a respective one of cap blow-mold sub-assembly gutter flash clamping surface guide pin receivers.

50. The apparatus invention defined by claim 43, wherein said cap blow-mold sub-assembly gutter flash clamping surface comprises a substantially flat and continuous surface extending outwardly away from said cap blow-mold sub-assembly product cavity mold parting-line perimeter and with increasing gutter flash clamping surface departure away from said base blow-mold sub-assembly gutter plate segment gutter flash clamping surfaces, and wherein said cap blow-mold sub-assembly gutter flash clamping surface is positioned interiorly of an adjacent one of said crash pad elements.

51. The blow-mold assembly invention defined by claim 50, and wherein said cap blow-mold sub-assembly substantially flat gutter flash clamping surface increasing surface departure is at least approximately one-degree (1°).

52. The blow-mold assembly invention defined by claim 43, wherein said cap blow-mold sub-assembly gutter flash clamping surface comprises an otherwise substantially flat and continuous gutter flash clamping surface that has an intermediate offset step and that extends away from said cap blow-mold sub-assembly product cavity mold parting-line perimeter with increasing gutter flash clamping surface departure away from said base blow-mold sub-assembly gutter plate segment gutter flash clamping surfaces, and wherein said cap blow-mold sub-assembly gutter flash clamping surface is positioned interiorly of an adjacent one of said crash pad elements.

53. The blow-mold assembly invention defined by claim 43 further comprising coolant passages formed in said elongate gutter plate segments adjacent said product cavity mold parting-line perimeter.

54. The blow-mold assembly invention defined by claim 43 further comprising a recessed section formed in one of said cap blow-mold sub-assembly gutter flash clamping surface or said gutter plate segment gutter flash clamping surface to provide a section of gutter flash attached to said product.

55. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold assembly, comprising:
a cap blow-mold sub-assembly having a product cavity that is defined in-part by a cavity mold parting-line perimeter and that is surrounded by a cap blow-mold sub-assembly gutter flash clamping surface extending outwardly from said product cavity mold parting-line perimeter;
a base blow-mold sub-assembly having a support structure, and having a product cavity that is carried by said support structure and that is defined in-part by a cavity mold parting-line perimeter corresponding to said cap blow-mold sub-assembly product cavity mold parting-line perimeter;
two elongate gutter plate segments that are each pivotally connected to and movable relative to said base blow-mold sub-assembly support structure, that together surround said base blow-mold sub-assembly product cavity mold parting-line perimeter when end-butted, that each have two pivot connections, each of said two pivot connections being located in a different one of the elongate gutter plate segment end regions, that each have a gutter flash clamping surface opposing and spaced-apart from said cap blow-mold sub-assembly gutter flash clamping surface;
a bi-directional gutter plate segment drive that is carried by said base blow-mold sub-assembly support structure, that is co-operably connected to said base blow-mold sub-assembly gutter plate segments, and that is actuated to cause pivoting of each said base blow-mold sub-assembly elongate gutter plate segment relative to said base blow-mold sub-assembly product cavity mold parting-line perimeter in directions away from said base blow-mold sub-assembly product cavity mold cavity parting-line perimeter to separate integrally attached gutter flash from the product progressively along said base blow-mold sub-assembly product cavity mold cavity parting-line perimeter, said elongate gutter plate segment pivot connections each having a longitudinal pivot axis oriented normal to the plane of said base blow-mold sub-assembly product cavity mold cavity parting-line perimeter, and each said elongate gutter plate segment pivot connection permitting its co-operating elongate gutter plate segment to be translated linearly in directions parallel the plane of said base blow-mold sub-assembly product cavity mold parting-line perimeter when separating integrally attached gutter flash from the product progressively along said base blow-mold sub-assembly product cavity mold cavity parting-line perimeter.

56. The blow-mold assembly invention defined by claim 55, and wherein said bi-directional gutter plate segment drive is comprised of two, independently-controlled, linearly extendible and retractable, actuator devices, and of two linearly extendable and retractable double-slotted wedging cams that are each connected to a different one of said two linearly extendible and retractable actuator devices, each of said two linearly extendible and retractable double-slotted wedging cams cooperating with a different pair of said two gutter plate segment pivot connections located in adjacent elongate gutter plate segment end regions.

57. The blow-mold assembly invention defined by claim 56, and additionally comprising a programmable sequence controller that is controllably connected to said bi-directional gutter plate segment drive two extendable and retractable actuator devices, and that is programmed with respect to said two linearly extendable and retractable double-slotted wedging cams to sequentially first extend one of said double-slotted wedging cams and afterwards extend the other of said two double-slotted wedging cams to thereby pivot said gutter plate segments to progressively separate surrounding gutter flash from the thermoplastic resin product.

58. The blow-mold assembly invention defined by claim 55, and wherein said bi-directional gutter plate drive is comprised of a linearly extendible and retractable actuator device, of a bi-directionally rotated and double-slotted drive cam that is rotated by said linearly extendible and retractable actuator device, and of two, linearly extendable and retractable, double-slotted wedging cams that each co-operate with two of said gutter plate segment pivot connections located in a different pair of elongate gutter plate segment adjacent end regions, said bi-directionally rotated double-slotted drive cam having two spaced-apart drive slots that each co-operated with a different one of said linearly extendable and retractable double-slotted wedging cams, and sequentially extending said co-operating two, linearly extendable and retractable, double-slotted wedging cams to thereby progressively separate surrounding gutter flash from the thermoplastic resin product.

59. The blow-mold assembly invention defined by claim 55 further comprising coolant passages formed in said elongate gutter plate segments adjacent said product cavity mold parting-line perimeter.

60. The blow-mold assembly invention defined by claim 55 further comprising a recessed section formed in one of said cap blow-mold sub-assembly gutter flash clamping surface or said gutter plate segment gutter flash clamping surface to provide a section of gutter flash attached to said product.

61. In a method of separating integrally-attached gutter flash from a hollow molded product having a product surrounding mold parting line perimeter and a product interior mold parting-line perimeter interior, the steps of:
forming, from a heated thermoplastic resin parison, a blow-molded product having an exterior, integrally-attached gutter flash extending away from the product surrounding mold parting line;
forming, from said heated thermoplastic resin parison, a blow-molded gutter flash core extending to the product interior mold parting-line perimeter and having an integral elongate bellows void;
progressively separating said blow-molded product exterior, integrally-attached gutter flash from said blow-molded product, and
collapsing said blow-molded gutter flash core integral elongate bellows void to thereby separate said gutter flash core from said blow-molded product.

62. The method invention defined by claim 61, and wherein said steps of progressively separating said blow-molded product exterior, integrally-attached gutter flash from said blow-molded product, and of collapsing said gutter flash core integral elongate bellows void to thereby separate said gutter flash core from said blow-molded product are accomplished simultaneously.

63. The method invention defined by claim 61, and wherein said step of collapsing said blow-molded gutter flash core integral elongate bellows void to thereby separate said gutter flash core from said blow-molded product is accomplished progressively along the length of said gutter flash core elongate bellows void.

64. In a blow-mold assembly which processes a heated thermoplastic resin parison to form a hollow blow-molded thermoplastic resin product having an interior through-opening mold parting-line perimeter and having an integrally-attached gutter flash core that extends to the product interior through-opening mold parting-line perimeter, and which separates the integrally-attached gutter flash core from the hollow blow-molded product while that product is retained in the blow-mold assembly, in combination:
a cap blow-mold sub-assembly having an interior gutter flash core clamping surface that extends to the product interior through-opening mold parting-line perimeter and having an elongate bellows void cavity recessed in said interior gutter flash core clamping surface;
a base blow-mold sub-assembly having a support structure, having a bellows block carried by said support structure, and having an elongate bellows void cavity recessed in said bellows block in registration with said cap blow-mold sub-assembly elongate bellows void cavity;
two base blow-mold sub-assembly gutter plate segments that are each pivoted relative to said base blow-mold sub-assembly support structure and the product interior through-opening mold parting-line perimeter, that extend to the product interior through-opening mold parting-line perimeter and are separated from each other by an elongate bellows gap registering with said cap and base blow-mold sub-assembly elongate bellows void cavities, that each have two pivot connections each one of which is located adjacent a different end of the elongate bellows gap separating said gutter plate segments, that each have a gutter flash core clamping surface opposing and spaced-apart from said cap blow-mold sub-assembly interior gutter flash core clamping surface;
a bi-directional gutter plate segment drive that is carried by said base blow-mold sub-assembly support structure, that is co-operably connected to said base blow-mold sub-assembly gutter plate segments, and that is actuated to cause pivoting of each said base blow-mold sub-assembly gutter plate segment relative to said base blow-mold sub-assembly support structure and the product interior through-opening mold parting-line perimeter to separate the integrally attached gutter flash core from the product progressively along the product interior through-opening mold parting-line perimeter, said gutter plate segment pivot connections each having a longitudinal pivot axis oriented normal to the plane of the product interior through-opening mold parting-line perimeter, and each said gutter plate segment pivot connection permitting its co-operating gutter plate segment to be rotated in directions parallel to the plane of the product interior through-opening mold parting-line perimeter when separating the integrally-attached gutter flash core from the product along the product interior through-opening mold parting-line perimeter.

65. The blow-mold assembly invention defined by claim 64, and wherein said cap blow-mold sub-assembly interior gutter flash core clamping surface comprises a substantially flat and continuous surface extending away from said cap blow-mold sub-assembly product interior through-cavity mold parting-line perimeter and with increasing gutter flash clamping surface departure away from said base blow-mold sub-assembly two gutter plate segment gutter flash clamping surfaces.

66. The blow-mold assembly invention defined by claim 65, and wherein said cap blow-mold sub-assembly substantially flat and continuous interior gutter flash core clamping surface increasing surface departure is at least approximately a one-degree (1°) or greater angular departure.

67. The blow-mold assembly invention defined by claim 64, and wherein said cap blow-mold sub-assembly interior gutter flash core clamping surface comprises an otherwise substantially flat and continuous interior gutter flash core clamping surface that has an intermediate offset step and that extends away from said cap blow-mold sub-assembly product interior through-opening mold parting-line perimeter with increasing interior gutter flash core clamping surface angular departure away from said base blow-mold sub-assembly gutter plate segment gutter flash core clamping surfaces.

68. The blow-mold assembly invention defined by claim 64 wherein each gutter plate segment has an excess gutter flash receiver element that is recessed in and open relative to said gutter plate segment gutter flash core clamping surface.

69. The blow-mold assembly invention defined by claim 68, and wherein said excess gutter flash receiver elements are each comprised of multiple blind-hole recesses provided in a respective one of said base blow-mold sub-assembly gutter plate segment interior gutter flash core clamping surfaces.

70. The blow-mold assembly invention defined by claim 68, and wherein said excess gutter flash receiver elements are each comprised of an elongated and continuous blind-slot that is recessed in a respective one of said base blow-mold sub-assembly gutter plate segment interior gutter flash core clamping surfaces.

71. The blow-mold assembly invention defined by claim 64, further comprising coolant passages formed in said elongate gutter plate segments adjacent said product cavity mold parting-line perimeter.

72. The blow-mold assembly invention defined by claim 64, further comprising a recessed section formed in one of said cap blow-mold sub-assembly gutter flash clamping surface or said gutter plate segment gutter flash clamping surface to provide a section of gutter flash attached to said product.

73. A blow-mold assembly for use in a blow-molding machine which processes a heated thermoplastic resin parison to form a blow-molded thermoplastic resin product having integrally-attached gutter flash surrounding the product and an integrally-attached interior gutter flash core, and to progressively separate the surrounding gutter flash and interior gutter flash core from the product while the product is retained in the blow-mold assembly, comprising:
a cap blow-mold sub-assembly having a product cavity that is defined in-part by a product cavity mold parting-line perimeter and that is surrounded by a cap blow-mold sub-assembly exterior gutter flash clamping surface extending outwardly from said product cavity mold parting-line perimeter, and having an interior gutter flash core clamping surface that is defined by a product interior through-opening mold parting-line perimeter and that has an elongate bellows void cavity recessed in said interior gutter flash core clamping surface;
a base blow-mold sub-assembly having a support structure, having a product cavity that is carried by said support structure and that is defined in-part by a product cavity mold parting-line perimeter corresponding to said cap blow-mold sub-assembly product cavity mold parting-line perimeter, having a bellows block carried by said support structure, and having an elongate bellows void cavity recessed in said bellows block in registration with said cap blow-mold sub-assembly elongate bellows void cavity;
two elongate exterior gutter plate segments that are each pivotally connected to and movable relative to said base blow-mold sub-assembly support structure, that together surround said base blow-mold sub-assembly product cavity mold parting-line perimeter when end-butted, that each have two pivot connections, each of said two pivot connections being located in a different one of the elongate gutter plate segment end regions, that each have a gutter flash clamping surface opposing and spaced-apart from said cap blow-mold sub-assembly gutter flash clamping surface;
two interior gutter plate segments that are each pivoted relative to said base blow-mold sub-assembly support structure and the product interior through-opening mold parting-line perimeter, that extend to the product interior through-opening mold parting-line perimeter and are separated from each other by an elongate bellows gap registering with said cap and base blow-mold sub-assembly elongate bellows void cavities, that each have two pivot connections each one of which is located adjacent a different end of the elongate bellows gap separating said gutter plate segments, that each have a gutter flash core clamping surface opposing and spaced-apart from said cap blow-mold sub-assembly interior gutter flash core clamping surface, and
a bi-directional gutter plate segment drive that is carried by said base blow-mold sub-assembly support structure, that is co-operably connected to said base blow-mold sub-assembly exterior and interior gutter plate segments, and that is actuated to cause pivoting of each said base blow-mold sub-assembly exterior or interior gutter plate segment;
said elongate gutter plate segment pivot connections and said interior gutter plate segment pivot connections each having a longitudinal pivot axis oriented normal to the plane of said base blow-mold sub-assembly product cavity mold cavity parting-line perimeter, and each said exterior elongate gutter plate segment pivot connection or said interior gutter plate segment pivot connection permitting its respective co-operating gutter plate segment to be translated linearly in directions parallel to the plane of said base blow-mold sub-assembly product cavity mold parting-line perimeter when separating integrally-attached surrounding gutter flash and interior gutter flash core from the blow-molded product progressively along said base blow-mold sub-assembly product cavity mold cavity parting-line perimeter and along said base blow-mold sub-assembly product interior through-opening mold parting-line perimeter while the blow-molded product is retained in the blow-mold assembly.

74. The blow-mold assembly invention defined by claim 73, further comprising coolant passages formed in said elongate gutter plate segments adjacent said product cavity mold parting-line perimeter.

75. The blow-mold assembly invention defined by claim 73, further comprising a recessed section formed in one of said cap blow-mold sub-assembly gutter flash clamping surface or said gutter plate segment gutter flash clamping surface to provide a section of gutter flash attached to said product.

76. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold sub-assembly, and comprising:
a cap blow-mold sub-assembly having a product cavity that is defined in-part by a mold parting-line perimeter, and that is surrounded by a cap blow-mold sub-assembly gutter flash clamping surface extending outwardly from said product cavity mold parting-line perimeter;
a base blow-mold sub-assembly having a support structure, and having a product cavity that is carried by said support structure and that is defined in-part by a mold parting-line perimeter corresponding to said cap blow-mold sub-assembly product cavity mold parting-line perimeter;
multiple base blow-mold sub-assembly elongate gutter plate segments that are each pivotable and movable relative to said base blow-mold sub-assembly support structure, that together surround said base blow-mold sub-assembly product cavity mold parting-line perimeter when end-abutted, that each have two, spaced-apart pivot connections each of which is positioned in a different one of the elongate gutter plate segment end regions, that each have a gutter flash clamping surface opposing and spaced-apart from said cap blow-mold sub-assembly gutter flash clamping surface;
a controlled bi-directional gutter plate segment drive that is actuated to cause pivoting of each said elongate gutter plate segments in directions that do not intersect the plane of said base blow-mold sub-assembly product cavity mold parting-line perimeter to separate the product surrounding gutter flash from the product progressively along said base blow-mold sub-assembly product cavity mold parting-line perimeter;
ejector pin elements provided in at least one of said base blow-mold assembly multiple elongate gutter plate segments;
a multi-ramp slide member mounted on at least one of said elongate gutter plate segments;
each ejector pin element engaging one ramp of said multi-ramp slide member;
bi-directional ramp slide member actuator movable between one and another positions wherein said ejector pins are extended outwardly of said gutter flash clamping surface when said actuator is in said one said positions and wherein said ejector pins are retracted inwardly of said gutter flash clamping surface when said actuator is in said other positions.

77. The blow-mold assembly invention defined by claim 76 further comprising a biasing element operatively connected to each of said ejector pin elements and biasing said ejector pin elements into contact with its respective multi-ramp slide member ramp.

78. The blow-mold assembly invention defined by claim 76 further comprising coolant passages formed in said elongate gutter plate segments adjacent said product cavity mold parting-line perimeter.

79. The blow-mold assembly invention defined by claim 76 further comprising a recessed section formed in one of said cap blow-mold sub-assembly gutter flash clamping surface or said gutter plate segment gutter flash clamping surface to provide a section of gutter flash attached to said product.

80. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold sub-assembly, and comprising;
a cap blow-mold sub-assembly having a product cavity that is defined in-part by a mold parting-line perimeter, and that is surrounded by a cap blow-mold sub-assembly gutter flash clamping surface extending outwardly from said product cavity mold parting-line perimeter;
a base blow-mold sub-assembly having a support structure, and having a product cavity that is carried by said support structure and that is defined in-part by a mold parting-line perimeter corresponding to said cap blow-mold sub-assembly product cavity mold parting-line perimeter;
multiple base blow-mold sub-assembly elongate gutter plate segments that are each pivotable and movable relative to said base blow-mold sub-assembly support structure, that together surround said base blow-mold sub-assembly product cavity mold parting-line perimeter when end-abutted, that each have two, spaced-apart pivot connections each of which is positioned in a different one of the elongate gutter plate segment end regions, that each have a gutter flash clamping surface opposing and spaced-apart from said cap blow-mold sub-assembly gutter flash clamping surface;
a controlled bi-directional gutter plate segment drive that is actuated to cause pivoting of each said elongate gutter plate segments in directions that do not intersect the plane of said base blow-mold sub-assembly product cavity mold parting-line perimeter to separate the product surrounding gutter flash from the product progressively along said base blow-mold sub-assembly product cavity mold parting-line perimeter;
at least one extensible and retractable spacer elements mounted in said base blow-mold sub-assembly support structure beneath said elongate gutter plate segments;
a ramped slide member mounted in said base blow-mold sub-assembly having at least one ramp which receives said space elements;
a bi-directional actuator operatively connected to said ramped slide member and movable between one and another positions wherein in said one position said spacer element is extended and engages said elongate gutter plate segment to define the space between said cap blow-mold sub-assembly gutter flash clamping surface and said gutter plate segment gutter flash clamping surface.

81. The blow-mold assembly of claim 80 further comprising coolant passages formed in said elongate gutter plate segments adjacent said product cavity mold parting-line perimeter.

82. The blow-mold assembly of claim 80 further comprising a recessed section formed in one of said cap blow-mold sub-assembly gutter flash clamping surface or said gutter plate segment gutter flash clamping surface to provide a section of gutter flash attached to said product.

83. A blow-mold assembly for use in a blow-molding machine which processes a heated thermoplastic resin parison to form a blow-molded thermoplastic resin product having integrally attached gutter flash surrounding the product, and to progressively separate the surrounding gutter flash from the product while the product is retained in the blow-mold sub-assembly, and comprising:
a cap blow-mold sub-assembly having a product cavity that is defined in-part by a mold parting-line perimeter, and that is surrounded by a cap blow-mold sub-assembly gutter flash clamping surface extending outwardly from said product cavity mold parting-line perimeter;
a base blow-mold sub-assembly having a support structure, and having a product cavity that is carried by said support structure and that is defined in-part by a mold parting-line perimeter corresponding to said cap blow-mold sub-assembly product cavity mold parting-line perimeter;
multiple base blow-mold sub-assembly elongate gutter plate segments that are each pivotable and movable relative to said base blow-mold sub-assembly support structure, that together surround said base blow-mold sub-assembly product cavity mold parting-line perimeter when end-abutted, that each have two, spaced-apart pivot connections each of which is positioned in a different one of the elongate gutter plate segment end regions, that each have a gutter flash clamping surface opposing and spaced-apart from said cap blow-mold sub-assembly gutter flash clamping surface;
a controlled bi-directional gutter plate segment drive that is actuated to cause pivoting of each said elongate gutter plate segments in directions that do not intersect the plane of said base blow-mold sub-assembly product cavity mold parting-line perimeter to separate the product surrounding gutter flash from the product progressively along said base blow-mold sub-assembly product cavity mold parting line perimeter;
at least one extensible and retractable crash pad element mounted in said base blow-mold sub-assembly support structure beneath said elongate gutter plate segments;
a ramped slide member mounted in said base blow-mold sub-assembly having at least one ramp which receives one end of said crash pad element;
a bi-directional actuator operatively connected to said ramped slide member and operable to move said ramped slide member between one and another positions wherein in said one position said crash pad element projects beyond said gutter plate segment gutter flash clamp surface to engage a cap blow-mold crash pad and in said another position said crash pad element is retracted to a position beneath said elongate gutter plate segment.

84. The blow-mold assembly invention of claim 83 further comprising coolant passages formed in said elongate gutter plate segments adjacent said product cavity mold parting-line perimeter.

85. The blow-mold assembly invention of claim 83 further comprising a recessed section formed in one of said cap blow-mold sub-assembly gutter flash clamping surface or said gutter plate segment gutter flash clamping surface to provide a section of gutter flash attached to said product.
